(19) United States
(12) Patent Application Publication
(10) Pub. No.: US 2026/0350731 A1
(43) Pub. Date: Nov. 5, 2026

(54) SYSTEM AND METHOD FOR AUTOMATICALLY GENERATING AND DISPLAYING A MATRIX DATA STRUCTURE

(71) Applicant: Level ADR Inc., New York, NY (US)

(72) Inventor: David Alan LeVine, Sarasota, FL (US)

(73) Assignee: Level ADR Inc., New York, NY (US)

(21) Appl. No.: 19/198,381

(22) Filed: May 5, 2025

(51) Int. Cl. G06Q 50/18

(52) U.S. Cl. CPC G06Q 50/188; G06Q 50/182

(57) ABSTRACT

A non-transitory computer readable media comprises computer program code that when executed by a programmable processor causes execution of a method, performed by a computer system, for generating and displaying a matrix data structure to more efficiently store data points and the relationship and conditions between them. The non-transitory computer readable media comprises computer program code for receiving, across independent offer channels, one or more offers from one or more offering parties and providing the one or more offers to one or more responding parties through the user interface via the communication network, receiving one or more responses to the one or more offers from the one or more responding parties, maintaining logical relationships between the one or more offers by tracking related offers and conditional dependencies, and displaying to the one or more offering parties and the one or more responding parties, a visual representation of multi-party settlement negotiations.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records but otherwise reserves all copyright rights whatsoever.

### BACKGROUND OF THE INVENTION

### Field of the Invention

This application generally relates to the field of legal settlement management, and more specifically, but not exclusively, to computer-implemented systems and methods for generating and displaying a matrix data structure to more efficiently store data points and the relationships and conditions between them to manage and visualize complex multi-party negotiations.

### Description of the Related Art

Settlement negotiations in legal disputes are complex and challenging to manage, particularly when multiple parties are involved. In simple two-party negotiations, offers and counteroffers can be tracked through direct correspondence, but this approach becomes exponentially more complicated when multiple parties are involved on either or both sides of a dispute. For instance, when multiple parties make concurrent offers, tracking the relationships and dependencies between these offers becomes technically challenging. The complexity of the settlement negotiations increases exponentially with each additional party.

Often, multi-party settlement negotiations include offers made with conditional dependencies. Parties making an offer may require certain conditions are met in order for the offers to be accepted. With multiple parties making offers including conditional dependencies, it is harder to maintain and visualize the chronological progression of offers and counteroffers. This makes it difficult to understand the evolution of settlement negotiations. It is also difficult to maintain clear and accurate records of the settlement negotiations and to create settlement documents based on the negotiations free of errors and inconsistencies. With settlement negotiations becoming more complex, there is a great need to manage these complex negotiations in an efficient and accurate manner.

Existing methods for managing multi-party settlements are inadequate in solving these problems. For example, traditional systems typically rely on manual tracking of offers and counteroffers through spreadsheets, email chains, or paper documentation. These approaches present several significant technical challenges. Traditional systems lack the technical capability to manage offers between multiple parties and automatically validate and enforce conditional offers. Existing solutions struggle to maintain and visualize the chronological progression of offers and counteroffers across multiple parties while also maintaining a consistent and accurate record of all offers, responses, and conditions across multiple parties.

Previous attempts to solve these problems have typically focused on simple two-party negotiations or have addressed only specific aspects of the multi-party settlement process. These solutions have failed to provide a comprehensive technical framework for managing the full complexity of multi-party settlement negotiations. While various legal practice management or ADR platforms may offer partial solutions, they do not sufficiently automate conditional validation, matrix-based visualization, or robust document generation for multi-party settings and are deficient in solving the issues presented above with respect to complex multi-party settlement negotiations.

For example, in U.S. Pat. No. 7,024,397, the web-based method allows for two parties to negotiate and execute a real estate lease, however, this method is deficient because it is not capable of managing negotiations between multiple parties including complex conditions. In U.S. Patent Application Publication No. 2005/0203785, a system and method for automating settlement of monetary disputes between two parties is provided, however, the system and method are deficient because they lack a structured interface for managing multi-party interactions and fail to provide real-time tracking or integration with external legal systems. In European Patent No. 0954817, buyers present conditional purchase offers to potential sellers and allows sellers to bind them, however, the method is deficient because it fails to provide a dynamic-settlement matrix capable of managing multiple parties including multiple offers and responses in real-time including conditional dependencies.

Some existing third-party legal settlement systems, including Lexis Nexis and American Arbitration Association's Online Settlement Tool, provide analytical and online dispute resolution support. However, these systems primarily focus on settlement analytics or direct two-party mediation without a structured multi-party negotiation framework.

The current solutions are thus incomplete when it comes to managing and visualizing multi-party complex settlement negotiations. Existing patents and systems fail to provide the dynamic, matrix-based, real-time offer processing framework of the present invention. Furthermore, they do not provide the capability to process and validate multiple conditional dependencies of offers, maintain temporal records of the progression of the negotiations, or maintain consistent and accurate records of all offers and responses throughout the negotiations.

Therefore, there is a need in the art for improved methods and systems for generating and displaying a matrix data structure to more efficiently store data points and the relationships and conditions between them to manage complex multi-party settlement negotiations.

### SUMMARY OF THE INVENTION

The present invention provides a method and system for visualizing and managing multi-party settlement negotiations. According to one embodiment, a non-transitory computer readable media comprises computer program code that when executed by a programmable processor causes execution of a method. The method, performed by a computer system, is for automatically generating and displaying a matrix data structure to more efficiently store data points and the relationships and conditions between them. The non-transitory computer readable medium comprises computer program code for receiving, across independent offer channels over a communication network, one or more offers from one or more offering parties through a user interface and computer program code for providing the one or more offers to one or more responding parties through the user interface via the communication network.

The non-transitory computer readable media also comprises computer program code for receiving one or more responses to the one or more offers from the one or more responding parties via the computer network and computer program code for maintaining logical relationships between the one or more offers by tracking related offers and conditional dependencies. The non-transitory computer readable media further comprises computer program code for displaying to the one or more offering parties and the one or more responding parties, through the user interface, a visual representation of multi-party settlement negotiations. The multi-party settlement negotiations comprise the one or more offers and the one or more responses over time.

In some embodiments, the non-transitory computer readable media can further comprise computer program code for creating a status of an offer state for each of the one or more offers as the one or more offers are received and updating the status of the offer state continuously throughout the multi-party settlement negotiations. The non-transitory computer readable media can further comprise computer program code for updating the status of the offer state based on pre-defined roles of the one or more offering parties and the one or more responding parties. The non-transitory computer readable media can further comprise computer program code for providing an interactive timeline to track the one or more offers and the one or more responses continuously throughout the multi-party settlement negotiations.

In certain embodiments, the user interface can be a secure user interface comprising a unique login and authentication for each of the one or more offering parties and each of the one or more responding parties accessing the user interface. The user interface can comprise a dynamic matrix. The dynamic matrix can comprise an adjustable series of one or more rows and one or more columns. The adjustable series can be based on a number of the one or more offering parties and the one or more responding parties associated with the multi-party settlement negotiation.

The non-transitory computer readable media can further comprise computer program code for maintaining the logical relationships between the one or more offers by tracking any group offers and any combined offers. The group offers can require unanimous acceptance by all of the one or more offering parties and all of the one or more responding parties associated with the multi-party settlement negotiation. The non-transitory computer readable media can further comprise computer program code for detecting a group offer, tracking responses to the group offer from the one or more responding parties and accepting the group offer upon an agreement from all of the one or more responding parties.

The combined offers can require offers designated as linked offers by the one or more offering parties to be accepted together. The linked offers can be required to be accepted by one or more responding parties designated as linked responding parties by the one or more offering parties. The non-transitory computer readable media can further comprise computer program code for detecting a combined offer, tracking responses to the combined offer from the one or more linked responding parties, and accepting the combined offer upon an agreement from the one or more linked responding parties.

In certain other embodiments, the non-transitory computer readable can further comprise computer program code for detecting an acceptance of the one or more offers and generating settlement documents based on the detection of acceptance. The non-transitory computer readable media can further comprise computer program code for storing, in one or more databases, records of past negotiations and active negotiations. The stored records can be encrypted. The non-transitory computer readable media can further comprise computer program code for integrating with external legal systems. The non-transitory computer readable can further comprise computer program code for implementing role-based access control.

According to one embodiment, a computer-implemented method for generating and displaying a matrix data structure to more efficiently store data points and the relationships and conditions between them comprises receiving, across independent offer channels via a communication network, one or more offers from one or more offering parties through a user interface. The computer implemented method also comprises providing the one or more offers to one or more responding parties through the user interface via the communication network and receiving one or more responses to the one or more offers from the one or more responding parties via the communication network. The computer implemented method also comprises maintaining logical relationships between the one or more offers by tracking related offers and conditional dependencies and validating responses to the one or more offers based on the logical relationships.

In some embodiments, the computer-implemented method can further comprise displaying to the one or more offering parties and the one or more responding parties, through the user interface, a visual representation of the multi-party settlement negotiations. The multi-party settlement negotiations can comprise the one or more offers and the one or more responses over time. The computer-implemented method can further comprise creating a status of an offer state for each of the one or more offers as the one or more offers are received and updating the status of the offer state continuously throughout the multi-party settlement negotiations based on pre-defined roles of the one or more offering parties and the one or more responding parties. The computer-implemented method can further comprise providing an interactive timeline to track the one or more offers and the one or more responses continuously throughout the multi-party settlement negotiations.

In certain other embodiments, the user interface can comprise a dynamic matrix. The dynamic matrix can comprise an adjustable series of one or more rows and one or more columns. The adjustable series can be based on a number of the one or more offering parties and the one or more responding parties associated with the multi-party settlement negotiations.

The computer-implemented method can further comprise maintaining the logical relationships between the one or more offers by tracking group offers and combined offers. The group offers can require unanimous acceptance by all of the one or more responding parties associated with the multi-party settlement negotiations. The computer-implemented method can also comprise detecting a group offer, tracking responses to the group offer from the one or more responding parties, and accepting the group offer upon an agreement from all of the one or more responding parties.

The combined offers can require offers designated as linked offers by the one or more offering parties to be accepted together. The linked offers can be required to be accepted by one or more responding parties designated as linked responding parties by the one or more offering parties. The computer-implemented method can further comprise detecting a combined offer, tracking responses to the combined offer from the one or more linked responding parties, and accepting the combined offer upon an agreement from the one or more linked responding parties. The computer-implemented method can further comprise detecting an acceptance of the one or more offers and generating a settlement document based on the detection of acceptance.

The present invention further provides a non-transitory computer-readable medium storing instructions that when executed, implement a method for displaying a matrix data structure to more efficiently store data points and the relationships and conditions between them. In one embodiment, the computer-readable method comprises computer code for generating a temporal visualization of one or more offers from one or more offering parties and one or more responding parties, computer code for displaying relationships between the one or more offers via a graphical interface, and computer code for updating a status of the one or more offers continuously as the one or more offers are received from the one or more offering parties and one or more responses are received from the one or more responding parties.

In some embodiments, the computer-readable medium can comprise computer program code for providing interactive elements for viewing details of the one or more offers and the one or more responses and the status of the one or more offers and the one or more responses over time. The relationships between the one or more offering parties and the one or more responding parties can comprise conditional requirements across the one or more offers. The conditional requirements can comprise group offers and combined offers.

### BRIEF DESCRIPTION OF THE DRAWINGS

The present systems and methods are illustrated in the figures of the accompanying drawings which are meant to be exemplary and not limiting, in which like references are intended to refer to like or corresponding parts.

FIG. 1A illustrates a system architecture showing the data flow of a system for generating and displaying a matrix data structure according to an embodiment of the present invention.

FIG. 1B illustrates a non-transitory computer readable media system for generating and displaying a matrix data structure according to an embodiment of the present invention;

FIG. 2 illustrates system components of the system for generating and displaying a matrix data structure of FIG. 1A including a flowchart showing user initiation through to process completion;

FIG. 3A illustrates a dynamic matrix user interface of the system for generating and displaying a matrix data structure of FIG. 1A according to an embodiment of the present invention;

FIG. 3B illustrates the dynamic matrix user interface of FIG. 3A with group offer conditions activated;

FIG. 3C illustrates the dynamic matrix user interface of FIG. 3A with combined offer conditions activated;

FIG. 4A illustrates a temporal visualization diagram of multi-party settlement negotiations according to an embodiment of the present invention;

FIG. 4B illustrates a display of the temporal visualization diagram of FIG. 4A showing offer history between multiple parties over time;

FIG. 4C illustrates another display of the temporal visualization interface of FIG. 4A showing offer history between multiple parties over time with variable node sizes;

FIG. 4D illustrates a temporal visualization diagram of offers with conditional relationships according to an embodiment of the present invention;

FIG. 4E illustrates a display of conditional relationships of the temporal visualization diagram of FIG. 4D showing relationships and offer history between multiple parties over time;

FIG. 5 illustrates a flowchart for a method of generating and displaying a matrix data structure according to an embodiment of the present invention;

FIG. 6 illustrates a flowchart of an offer validation process of the method of FIG. 5 of the present invention;

FIG. 7A is a flowchart of a method for collecting and validating data from one or more parties according to an embodiment of the present invention;

FIG. 7B is a flowchart of a method for generating settlement documents based on the data collected in FIG. 7A of the present invention;

FIG. 7C is a flowchart showing a method for managing output of the data collected in FIG. 7A of the present invention;

FIG. 8A is a flowchart showing a standard offer sequence according to an embodiment of the present invention;

FIG. 8B is a flowchart showing a group offer sequence according to an embodiment of the present invention;

FIG. 8C is a flowchart showing a combined offer sequence according to an embodiment of the present invention;

FIG. 9 illustrates relationships between offers, parties, conditions, and responses according to an embodiment of the present invention;

FIG. 10 illustrates a security and data retention architecture of a system for visualizing and managing multi-party settlement negotiations according to an embodiment of the present invention; and

FIG. 11 illustrates an API integration framework for a system for visualizing and managing multi-party settlement negotiations with external systems according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized, and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

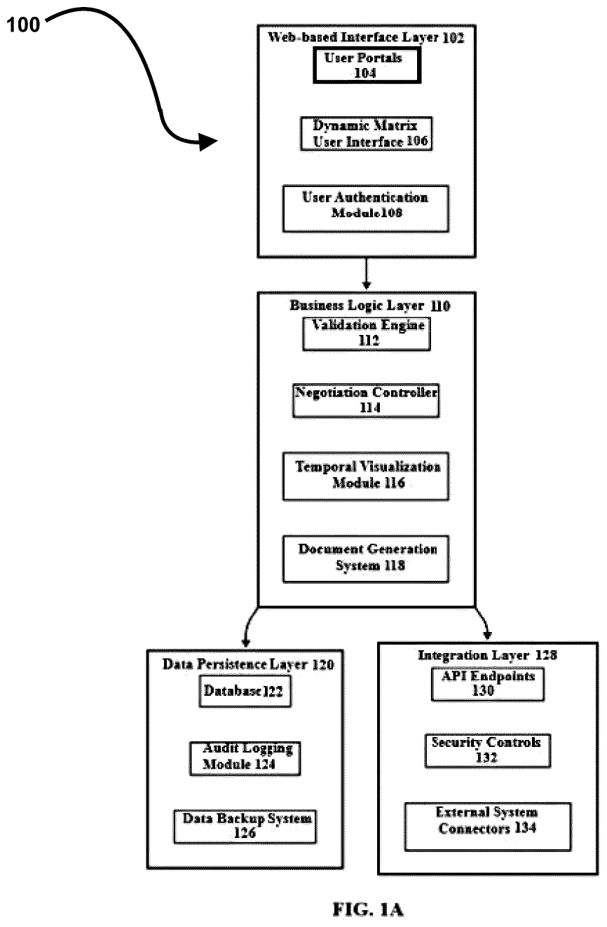

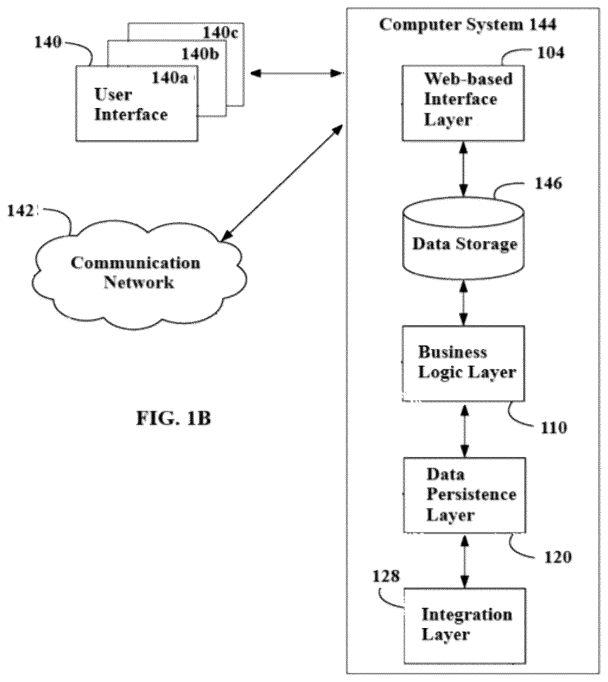

The present invention provides a method and system for generating and displaying a matrix data structure to more efficiently store data points and the relationships and conditions between them. A non-transitory computer readable media comprises several integrated components and layers that work together to facilitate complex settlement negotiations. With reference to FIG. 1A, a multi-layered system architecture 100 for generating and displaying a matrix data structure to more efficiently store data points and the relationships and conditions between them is shown. With reference to FIG. 1B, a non-transitory computer readable media system is shown which includes the muti-layered system architecture 100 of FIG. 1A. The multi-layered system architecture 100 includes a web-based interface layer 102, a business logic layer 110, a data persistence layer 120, and an integration layer 128. The arrows in FIG. 1A represent how data flows between the various layers of the multi-layer system architecture 100.

The web-based interface layer 102 provides user-facing screens accessed by users for creating, viewing, and responding to offers. The user-facing screens can be viewed on one or more user interfaces 140a-140n (e.g., as shown in FIG. 1B) on one or more user devices (e.g., phones, computers, and the like). The web-based interface layer 102 includes a user portal 104, a dynamic matrix user interface 106, and a user authentication module 108. The business logic layer 110 includes a validation engine 112 for validating offers and responses to offers, a negotiation controller 114 for conditional offer processing routines, and a temporal visualization module 116 for demonstrating the progression of the settlement negotiation to a user over time. The business logic layer 110 also includes a document generation system 118. The data persistence layer 120 manages storage of offers, responses, and party information to ensure auditability. The integration layer 128 offers APIs for external legal systems (e.g., court platforms and legal practice management software) to connect with the multi-party settlement system.

According to one embodiment, the non-transitory computer readable media comprises computer program code that when executed by a programmable processor causes execution of a method. The method, performed by a computer system 144 (e.g., as shown in FIG. 1B), is for automatically generating and displaying a matrix data structure to more efficiently store data points and the relationships and conditions between them The non-transitory computer readable media comprises computer program code for receiving one or more offers from one or more offering parties through a user interface 106 (e.g., dynamic matrix user interface as seen in FIG. 1A) across independent offer channels via a communication network 142 (e.g., as shown in FIG. 1B).

An offer can refer to any formal proposal made by one party (e.g., an offering party) to one or more other parties (e.g., a responding party) containing specific terms (e.g., monetary or non-monetary conditions) for resolving a dispute. Monetary terms can refer to specific numerical values. Non-monetary terms can include any settlement conditions or requirements that are not expressed as numerical values including but not limited to behavioral requirements, timing conditions, or other obligations. An offering party can be any party to a settlement negotiation who is currently making an offer to one or more other parties. Offer channels can refer to specific communication pathways between an offering party and a responding party and can be represented by a cell in a matrix interface. A responding party can be any party designated to receive and respond to an offer from an offering party.

The non-transitory computer readable media further comprises computer program code for providing the one or more offers to one or more responding parties through the user interface 106 via the communication network 142 and receiving one or more responses to the one or more offers from the one or more responding parties via the communication network 142. The non-transitory computer readable media comprises computer program code for maintaining logical relationships between the one or more offers by tracking related offers and conditional dependencies (e.g., via the validation engine 112 and negotiation controller 114) and displaying to the one or more offering parties and the one or more responding parties, through the user interface 106, a visual representation of multi-party settlement negotiations (e.g., via temporal visualization module 116), the multi-party settlement negotiations comprising the one or more offers and the one or more responses over time. The visual representation (e.g., temporal visualization) of the multi-party settlement negotiations can be a graphical representation of the one or more offers and one or more responses over time, showing the progression and relationships between the one or more offers and one or more responses.

In some embodiments, the non-transitory computer readable, media comprises computer program code for creating a status of an offer state for each of the one or more offers as the one or more offers are received and updating the status of the offer state continuously throughout the multi-party settlement negotiations. An offer state can refer to the current status of an offer processed by the system. The status of the offer state can be updated based on pre-defined roles of the one or more offering parties, the one or more responding parties, or any neutral third-party mediators. An offer can have any of the following designated offer states, including draft (e.g., pre-submission), pending (e.g., awaiting response), partial (e.g., some required acceptances have been received from some of the parties), accepted (e.g., all required acceptance have been received), rejected (e.g., at least one of the required parties has rejected the offer), expired (e.g., a time limit has exceeded), or withdrawn (e.g., offer has been removed by the offering party). The non-transitory computer readable media can comprise computer program code for providing an interactive timeline to track the one or more offers and the one or more responses continuously throughout the multi-party settlement negotiations.

With continued reference to FIG. 1A, the web-based interface layer includes user portals 104, the dynamic matrix user interface 106 (e.g., in FIG. 1B multiple user interfaces are shown 140a-140n), and a user authentication module 108. In certain embodiments, the user interface 106 can be a secure user interface comprising a unique login (e.g., which is entered through the user portal 104) and authentication (e.g., performed by the authentication module 108) for each of the one or more offering parties, each of the one or more responding parties, and any neutral third-party mediators accessing the user interface 106. For example, the secure user interface 106 can include enhanced security methods such as multi-factor authentication performed by the authentication module 108. The user portals 104 can include front-end web pages or dashboards through which the one or more parties (e.g., offering parties/claimants, responding parties/respondents, and neutral mediators) can login to the system and manage offers and responses.

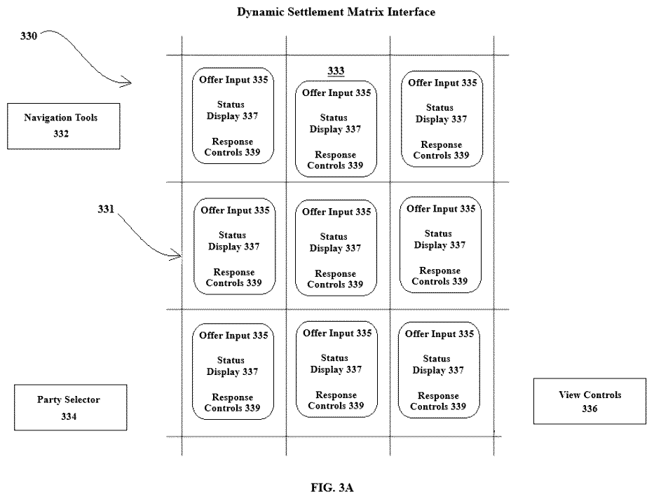

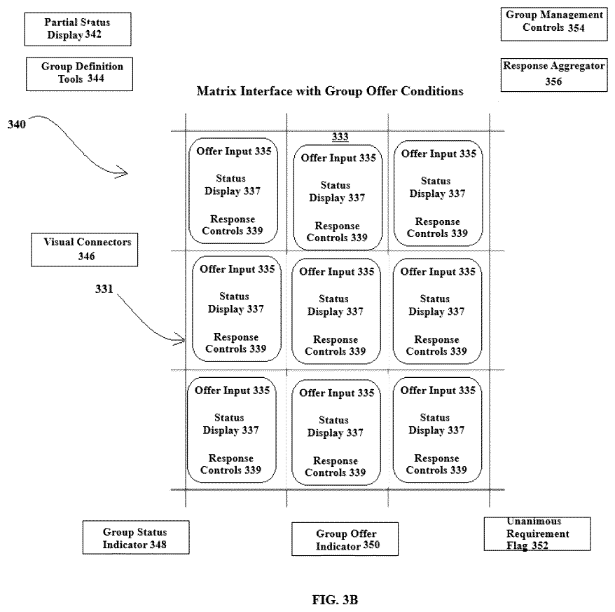

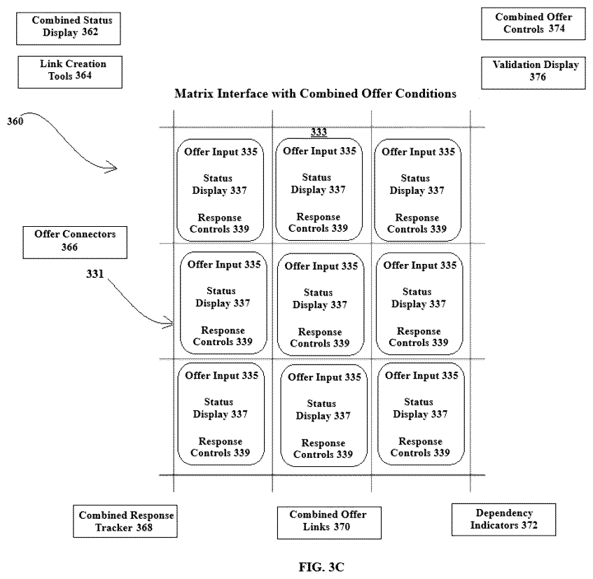

The user interface 106 can comprise a dynamic matrix (e.g., as shown in FIGS. 3A-3C) which is viewable to users. The non-transitory computer readable media generates and displays the dynamic matrix structure based on stored offer/response data as well as relationship and condition data associated with the parties and their offers/responses. The non-transitory computer readable media analyzes the offer/response data as well as relationship and condition data associated with the parties and their offers/responses and displays the data and connections to the offering, responding and any neutral parties through the user interface.

The dynamic matrix user interface 106 can comprise an adjustable series of one or more rows and one or more columns. The adjustable series can be based on a number of the one or more offering parties and the one or more responding parties associated with the multi-party settlement negotiation. The matrix interface 106 can be a dynamic tabular visualization, such that the columns can represent offering parties, and the rows can represent responding parties, or vice versa. Each cell in the tabular visualization can represent a potential offer channel between parties. The dynamic matrix interface 106 enables simultaneous visualization and management of offers between multiple parties, providing independent offer channels for each offering party, while maintaining logical relationships between related offers (e.g., group offers and combined offers).

The dynamic matrix user interface 106 is dynamically adjusted based on user-selected numbers of offering and responding parties. Excess party columns and rows in the matrix that are not selected are disabled (e.g., only active offer channels are managed during a settlement negotiation). The dynamic matrix user interface 106 and temporal visualization (via temporal visualization module 116) are implemented using web-based technologies. The following pseudocode provides an exemplary embodiment and is not meant to be taken in a limiting sense.

```
Real-Time Updates
class Matrix UpdateManager {
  constructor( ) {
    this.websocket = new WebSocket('wss://api.example.com/matrix');
    this.messageQueue = new PriorityQueue( );
    this.stateManager = new StateManager( );
  }
  handleUpdate(update) {
    // Optimistic UI update
    this.stateManager.applyUpdate(update);
    this.renderMatrix( );
    // Confirm with server
    this.websocket.send(JSON.stringify(update));
  }
}
Matrix Rendering
  class MatrixRenderer {
  constructor(container) {
    this.grid = new VirtualGrid({
      viewport: container,
      cellSize: { width: 200, height: 100 },
      renderBuffer: 5
    });
  }
  renderCell(row, col) {
    return new OfferCell({
      monetary: new DecimalField( ),
      terms: new RichTextEditor( ),
      status: new StatusIndicator( )
    });
  }
}
Temporal Visualization
class Timeline Visualizer {
  constructor(svgContainer) {
    this.svg = d3.select(svgContainer);
    this.zoomBehavior = d3.zoom( )
      .scaleExtent([0.5, 4])
      .on(‘zoom’, this.handleZoom);
  }
  renderTimeline(data) {
    // D3.js-based visualization
    this.svg.selectAll(‘circle’)
      .data(data)
      .join(‘circle’)
      .attr(‘r’, d => this.scaleAmount(d.value))
      .attr(‘cx’, d => this.timeScale(d.timestamp))
      .attr(‘cy’, d => this.partyScale(d.party));
  }
}
```

With continued reference to FIG. 1A, the business logic layer 110 includes validation engine 112, negotiation controller 114, temporal visualization module 116, and document generation system 118. The non-transitory computer readable media can comprise computer program code for maintaining the logical relationships between the one or more offers by tracking any conditional offers (e.g., group offers and combined offers). The validation engine 112 performs real-time checks to track group offers, combined offers, and any other conditional requirements. The negotiation controller 114 orchestrates the creation, update, and status changes for all offers. The temporal visualization module 116 gathers offer and response timestamps to render time-based visualizations to the parties.

Group offers can require unanimous acceptance by all of the one or more offering parties and all of the one or more responding parties associated with the multi-party settlement negotiation. The non-transitory computer readable media can comprise computer program code for detecting a group offer, tracking responses to the group offer from the one or more responding parties, and accepting the group offer upon an agreement from all of the one or more responding parties. A group offer can refer to a specific type of offer (e.g., a conditional offer) which is valid only if accepted by all parties designated by the offering party as responding parties. The offer is considered rejected if any one of the designated responding parties reject the offer, even if all the other parties have accepted it. When responses have been received from some but not all of the responding parties, the offer state status remains in a temporary state designated as partial acceptance, until responses have been received from all responding parties. If all parties accept, the offer state status is converted to full acceptance. If any required party rejects, the offer state status is converted to a rejection.

The non-transitory computer-readable media has computer program code that detects a group offer by flagging offers which require unanimous acceptance by all parties associated with a settlement negotiation. The validation engine 112 tracks responses from all parties associated with a multi-party settlement negotiation to determine whether conditions for an offer are met.

Combined offers can require offers designated as linked offers by the one or more offering parties to be accepted together. The linked offers can be required to be accepted by one or more responding parties designated as linked responding parties by the one or more offering parties. The non-transitory computer readable media further comprises computer program code for detecting a combined offer, tracking responses to the combined offer from the one or more linked responding parties, and accepting the combined offer upon an agreement from the one or more linked responding parties.

A combined offer can refer to an offer that must be accepted in conjunction with offers from co-parties. For example, one or more offering parties can designate one or more responding parties as linked responding parties such that the linked responding parties must accept or reject the offer as a unit. If all linked responding parties accept, the offer is validated. If any one of the linked responding parties rejects, the offer is invalidated. If responses have been received from some but not all of the linked responding parties, the offer status remains in a temporary partial state, until responses have been received from all linked responding parties. If all linked responding parties accept, the offer state status is converted to full acceptance. If any linked responding party rejects, the offer state status is converted to a rejection.

The non-transitory computer readable media comprises computer program code that detects a combined offer by flagging offers that are designated as linked offers by the one or more offering parties. The one or more offering parties can designate certain responding parties as linked responding parties, which sets the requirement that all linked responding parties must respond to the linked offer together for there to be acceptance. The validation engine 112 tracks all linked offers to ensure they are accepted by all linked responding parties. The system maintains visual indicators of offer linkages to make it easier to keep track of such offers.

The non-transitory computer readable media can further comprise computer program code for detecting an acceptance of the one or more offers and generating settlement documents based on the detection of acceptance (e.g., via document generation system 118). Settlement documents may refer to formal documentation generated based on accepted offers, incorporating all monetary and non-monetary terms and conditional requirements from the accepted offers.

Referring still to FIG. 1A, the non-transitory computer readable media can further comprise computer program code for storing, in one or more databases e.g., 146 of FIG. 1B), records of past negotiations and active negotiations. More specifically, the data persistence layer 120 includes database 122, audit logging module 124, and data backup system 126. The database 122 can store party records, offer data, response logs, and conditional dependencies for past and active negotiations. Offer history can be preserved in various storage databases until explicit clearing instructions of history is provided. Inactive negotiations can alternatively be moved to a separate archival database for a retention period before being deleted. After the retention period has expired, minimal audit trails are maintained by the system. The stored data records can be encrypted for enhanced security. The audit logging module 124 preserves a record of all changes to offers, responses, and system events throughout the settlement negotiations, including which party is responsible for which changes. Data backup system 126 maintains redundant copies of all negotiation data.

The non-transitory computer readable media can comprise computer program code for integrating with external legal systems through integration layer 128. The integration layer 128 includes API endpoints 130, security controls 132, and external system connectors 134. API endpoints 130 are configured to facilitate connections with the external legal systems and platforms. Security controls 132 can include encryption and role-based access mechanisms for access to the system through external legal systems. External system connectors 134 can include interfaces with external legal systems, for example, interfaces with court systems and document management services. Integration with any other type of non-legal external systems is also contemplated herein.

The systems and methods described herein are configured to implement event-driven architecture to ensure tight integration between modules and layers. This integration framework ensures consistent state propagation across modules, reliable error handling and recovery, coordinated real-time updates, maintainable module dependencies, verifiable system integrity, scalable event processing, and robust failure recovery. The following pseudocode and implementation details are presented solely for illustrative purposes to demonstrate one possible embodiment of system integration and module synchronization and is not meant to be taken in a limiting manner.

```
Inter-Module Communication Framework
class SystemEventBus {
  properties:
    subscribers: Map<ModuleID, Set<EventHandler>>
    eventQueue: PriorityQueue<SystemEvent>
    stateManager: GlobalStateManager
  methods:
    propagate_event(event: SystemEvent):
      validate_event_sequence(event)
      affected_modules = determine_affected_modules(event)
      transaction = begin_distributed_transaction( )
      try:
        for module in affected_modules:
          module_state = apply_event(module, event)
          verify_state_consistency(module_state)
          update_dependent_modules(module, event)
        commit_transaction(transaction)
      catch StateInconsistency:
        rollback_transaction(transaction)
        initiate_recovery_procedure( )
Module Dependency Graph
class ModuleDependencyManager {
  properties:
    module_graph: DirectedGraph<ModuleID>
    update_order: TopologicalSort<ModuleID>
    state_validators: Map<ModuleID, State Validator>
  methods:
    process_state_change(source_module, change):
      affected = calculate_downstream_impacts(source_module)
      ordered_updates = sort_by_dependency(affected)
      for module in ordered_updates:
        current_state = module.get_state( )
      new_state = apply_change(module, change)
      validate_state_transition(current_state, new_state)
propagate_to_dependents(module, new_state)
```

TABLE A

| | | | Rollback |
|---|---|---|---|
| Module | Dependencies | Update Priority | Strategy |
| Matrix UI | None | Immediate | Optimistic UI |
| Validation Engine | Matrix UI | High | State Recompute |
| Document Gen | Validation | Low | Version Control |
| External API | All | Async | Queue-Based |

Table A illustrates the integration and synchronization of various components of the system and how they interact with and depend on each other.

```
Error Propagation Handler
class ErrorPropagationManager {
handle_module_error(error, source_module):
      impact = analyze_error_impact(error)
      affected_modules = trace_dependency_chain(source_module)
    for module in affected_modules:
    if requires_immediate_action(module, error):
      pause_module_operations(module)
      initiate_recovery(module)
    else:
      queue_delayed_recovery(module)
    notify_system_monitors(error, affected_modules)
Real-Time Update Coordinator
class UpdateCoordinator {
properties:
    active_updates: Map<UpdateID, UpdateContext>
    module_states: Map<ModuleID, ModuleState>
methods:
    coordinate_update(update):
    modules = identify_affected_modules(update)
    sequence = determine_update_sequence(modules)
    for phase in sequence:
      status = execute_phase_updates(phase)
      if status.requires_verification:
        verify_phase_consistency(phase)
      await_phase_completion(phase)
    handle_update_failure(failed_update):
    revert_incomplete_phases(failed_update)
    restore_consistent_state( )
    notify_affected_parties( )
Module Integration Points
class ModuleIntegrationManager {
register_module_hooks(module):
    entry_points = identify_integration_points(module)
    for point in entry_points:
    register_state_handler(point)
    setup_event_listeners(point)
    configure_error_handlers(point)
monitor_integration_health( ):
    for module in registered_modules:
    verify_communication_channels(module)
    check_state_consistency(module)
    validate_event_flow(module)
```

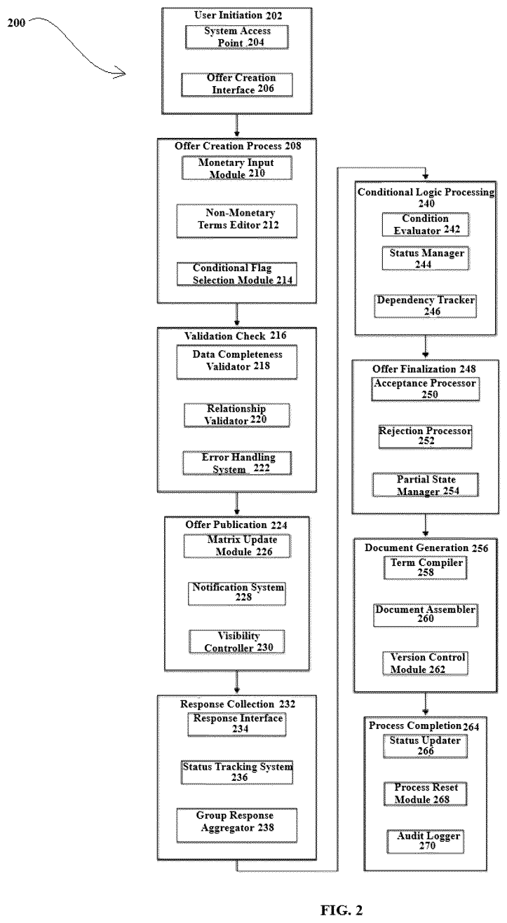

With reference to FIG. 2, a process flowchart for managing multi-party settlement negotiations 200 from user initiation 202 through to process completion 264 is shown. Offers are created by one or more offering parties in the user initiation phase 202. User initiation phase 202 includes system access point 204 which includes a secure login for each of the parties to access the system. Access point 204 further performs authentication of each of the parties accessing the system. User initiation phase 202 also includes an offer creation interface 206 which includes an initial screen displayed to the parties for initial offer setup.

Once a party has accessed the multi-party settlement negotiation system though the user initiation phase 202, the offer creation process 208 is initiated. In the offer creation phase 208, one or more offering parties input data for their offer. An offering party can enter monetary offer terms in a monetary input module 210. The monetary input module 210 includes fields for entering settlement amounts (e.g., numerical values). An offering party can also enter non-monetary offer terms in a non-monetary terms editor 212. The non-monetary terms editor 212 includes an interface for specifying non-monetary conditions to an offer. Finally, an offering party can also designate offers as group or combined offers through conditional flag selection module 214.

After an offer has been created, a validation check phase 216 is initiated by the system. The validation check phase 216 includes a data completeness validator 218 which checks that required fields have been fully and properly filled. The validation check phase 216 also includes relationship validator 220 which checks for party association and conditional relationships between parties. The validation check phase 216 also includes an error handling system 222 which accepts user feedback for any corrections.

With continued reference to FIG. 2, once the offer has been validated during the validation check phase 216, an offer publication phase 224 begins. Offer publication phase 224 includes a matrix update module 226 which updates the dynamic matrix interface 106 with the new offer. Offer publication phase 224 also includes a notification system 228 which alerts responding parties that an offer has been published in the system. The offer publication phase 224 also includes a visibility controller 230 which manages offer access permissions (e.g., which parties can access and respond to the offer).

The systems and methods described herein implement a comprehensive role-based access control system that extends beyond basic claimant/offering party and respondent/responding party distinctions. Role-specific features include but are not limited to mediator tools for suggesting terms, arbitrator dashboards for case management, observer-only views with limited data access, and administrative controls for system configurations. Access control implementation includes fine-grained permission management, context-aware access restrictions, temporal access limitations, and audit login for role-based actions.

TABLE B

| | Access | | |
|---|---|---|---|
| Role Type | Level | Capabilities | Restrictions |
| Mediator | Oversight | View All, | No Direct Offers |
| | | Suggest | |
| Arbitrator | Administrative | Full Access | Read-Only History |
| Observer | Limited | View Only | No Interaction |
| Administrator | System | Configuration | No Negotiation |

Table B illustrates examples of role types recognized by the system and access levels, capabilities, and restrictions based on each role type.

This role-based management system integrates with the dynamic settlement matrix 106 by dynamically adjusting matrix cell permissions based on party relationships, enabling mediator-specific views of conditional dependencies, providing role-appropriate temporal visualizations of negotiation progress, supporting concurrent multi-party authorization workflows for complex settlements, and maintaining comprehensive audit trails that link user actions to settlement states. The role-based management system addresses the complexities of multi-party settlement negotiations by enforcing role-specific validation rules for offer creation and response, managing cascading permissions across related settlement offers, providing role-appropriate intervention capabilities for deadlocked negotiations, enabling secure delegation of authority within party groups, and supporting dynamic role transitions as negotiations progress.

The following pseudocode and implementation details are presented solely for illustrative purposes to demonstrate one possible embodiment of role-based management of the system and is not meant to be taken in a limiting manner.

```
Permission Matrix:
class PermissionEngine:
  validate_action(user, action, context):
    role = get_user_role(user)
    permissions = get_role_permissions(role)
    if action.requires_special_handling:
      apply_role_specific_rules( )
      validate_temporal_constraints( )
check_conflict_of_interest( )
```

With continuing reference to FIG. 2, once responding parties are notified of offer publication, a response collection phase 232 is initiated. Response collection phase 232 includes a response interface 234 which includes a screen displayed to one or more responding parties allowing them to accept, reject, or provide counteroffers to an offer published by one or more offering parties. Response collection phase 232 further includes a status tracking interface 236 which monitors party responses and assigns an offer state status to the offers. The response collection phase 232 also includes a group response aggregator 238 which tracks responses flagged by the offering parties as related or linked (e.g., signifying either a group offer or combined offer requirement is present).

Once responses to the offers have been submitted by the responding parties, conditional logic processing phase 240 begins. Condition evaluator 242 checks to ensure all offer requirements have been met. Status manager 244 updates the offer state status based on the results from the condition evaluator 242. Dependency tracker 246 monitors responses to offers designated as linked offers by the offering party.

Referring still to FIG. 2, after conditional logic processing phase 240, offer finalization phase 248 is initiated. Offer finalization phase 248 includes an acceptance processor 250 which is configured to record the final offer state status. A rejection processor 252 manages offer invalidation for rejected offers. A partial state manager 254 tracks incomplete acceptances.

After offer finalization phase 248 is completed, document generation phase 256 begins. Document generation phase 256 includes aggregating all accepted offers by term compiler 258, including both monetary and non-monetary terms and any conditional requirements. Document generation phase 256 also includes creating documents which include all of the aggregated terms through document assembler 260. Version control module 262 maintains document history including any updates and edits to the documents.

After an agreement document based on the agreed upon terms has been generated, process completion phase 264 is initiated. Status updater 266 records the final offer state status. Process reset module 268 prepares the system to receive new offers. Finally, audit logger 270 records that the multi-party settlement negotiation is complete.

Referring now to FIG. 3A, an exemplary embodiment of a dynamic matrix interface 330 is shown. The dynamic settlement matrix provides an interface including a matrix framework 331. The matrix framework 331 includes a series of one or more columns (e.g., vertical columns) which can represent one or more offering parties, and a series of rows (e.g., horizontal rows) which can represent one or more responding parties. Alternatively, the one or more columns can represent one or more responding parties, and the one or more rows can represent one or more offering parties. Each column and row of the matrix framework 331 can include column headers and row headers (not shown) to identify the one or more offering parties and one or more responding parties. Each header is unique to an offering party and a responding party. The dynamic matrix framework 331 is displayed as a grid which can be updated based on the number of offering and responding parties associated with a settlement negotiation.

The dynamic matrix framework 331 is made up of one or more cells 333. Each cell 333 includes an offer input 335, which the one or more offering parties use to input their monetary (e.g., numerical value entry) and non-monetary (e.g., text input for conditions) offer terms. Each cell 333 also includes a status display 337 which shows an updated offer state status to all of the parties associated with a settlement negotiation. Finally, each cell 333 also includes response controls 339 by which the one or more responding parties can accept, reject or propose counteroffers to the offers from the one or more offering parties.

The dynamic matrix interface 330 includes interface controls including navigation tools 332, party selector 334, and view controls 336. Navigations tools 332 allow parties to navigate the matrix framework 331, for example, by scrolling and zooming. Party selector 334 allows for adding and removing party controls based on the roles of each party in a given settlement negotiation. View controls 336 display various options and filters to the parties for viewing the dynamic matrix interface 330.

The following pseudocode and implementation details are presented solely for illustrative purposes to demonstrate one possible embodiment of dynamic grid implementation and is not meant to be taken in a limiting manner.

```
Dynamic Grid Implementation
class MatrixInterface {
  properties:
    grid_layout: Map<PartyID, GridPosition>
    cell_states: Map<CellID, OfferState>
    view_controller: ViewController
  methods:
    initialize_matrix(offering_parties, responding_parties):
      validate_party_relationships( )
      calculate_grid_dimensions( )
      initialize_cell_containers( )
      setup_event_handlers( )
    handle_asymmetric_configuration( ):
      disabled_cells = identify_invalid_combinations( )
      apply_visual_state(disabled_cells, 'inactive')
      update_accessibility_attributes( )
Cell Component Management
class MatrixCell {
  properties:
    monetary_field: DecimalInput
    terms_editor: RichTextArea
    status_display: StatusIndicator
    response_controls: ActionButtons
  methods:
    render_cell_content( ):
      validate_permissions( )
      load_current_state( )
      setup_input_validation( )
      initialize_response_handlers( )
    update_cell_state(new_state):
      validate_state_transition(new_state)
      apply_visual_updates( )
      notify_state_changes( )
```

In FIG. 3B, a dynamic matrix interface with group offer conditions activated 340 is shown. The dynamic matrix interface 340 includes group offer indicators 350 which signify to the parties that a group offer has been initiated. Group offer indicators 350 include visual connectors 346 which can be lines that link related/associated parties together. Further, a unanimous requirement flag 352 can be used to signify that an offer is a group offer. A partial status display 342 can also be included to track responses from each individual responding party of a group offer until a response has been received from all of the responding parties. The dynamic matrix interface 340 also includes group management controls 354 which are used to track group offers. Group management controls include group definition tools 344 which allow offering parties to select parties for a group offer. A response aggregator 356 tracks responses from the parties designated as part of the group by the offering parties. A group status indicator 348 tracks the overall offer state status of the group offer.

The following pseudocode and implementation details are presented solely for illustrative purposes to demonstrate one possible embodiment of dynamic grid implementation including a group offer and is not meant to be taken in a limiting manner.

```
Group Offers
class GroupOfferManager {
  properties:
    group_mappings: Map<OfferID, Set<PartyID>>
    acceptance_tracker: Map<OfferID, AcceptanceState>
    visualization_controller: Group Visualizer
  methods:
    create_group_offer(source_party, target_parties):
      validate_group_composition( )
      initialize_acceptance_tracking( )
      setup_visual_indicators( )
      register_response_handlers( )
    process_group_response(response):
      current_state = acceptance_tracker.get(response.offer_id)
      updated_state = update_acceptance_state(current_state, response)
      validate_group_conditions(updated_state)
      propagate_state_changes( )
```

In FIG. 3C, a dynamic matrix interface with combined offer conditions activated 360 is shown. The dynamic matrix interface 360 includes combined offer links 370 which signify to the parties that an offer has been designated as a combined offer. Combined offer links 370 include offer connectors 366 which provide visual links between offers designated as related/linked by the one or more offering parties. Dependency indicators 372 show which offers are related/linked to the parties associated with a settlement negotiation. A combined status display 362 aggregates the offer state status from each of the linked responding parties. The dynamic matrix interface 360 also includes combined offer controls 374 which allow parties to manage the combine offers. Combined offer controls 374 include link creation tools 364 which provide an offer combination interface to one or more offering parties so the one or more offering parties can designate linked offers and linked responding parties. A validation display 376 shows the acceptance requirements for a particular combined offer. A combined response tracker 368 monitors responses from linked responding parties.

The following pseudocode and implementation details are presented solely for illustrative purposes to demonstrate one possible embodiment of dynamic grid implementation including a combined offer and is not meant to be taken in a limiting manner.

```
Combined Offers
class CombinedOfferManager {
  properties:
    offer_links: Map<OfferID, Set<OfferID>>
    dependency_validator: DependencyChecker
    state_coordinator: StateCoordinator
  methods:
    link_offers(offer_set):
      validate_offer_compatibility( )
      create_dependency_graph( )
      initialize_combined_state( )
      setup_visual_connectors( )
    handle_linked_response(response):
      affected_offers = get_linked_offers(response.offer_id)
      validate_combined_conditions(affected_offers)
      synchronize_offer_states(affected_offers)
```

Responding parties can submit counteroffers and counter conditions in response to offers from offering parties. The following pseudocode and implementations are provided to show a counteroffer tracking system for example only and are not meant to be taken in a limiting sense. Counteroffer management provides version control and history management through complete modification history, branching and merging of offer versions, conflict resolution for simultaneous modifications, and audit trail of all changes. Counteroffer management also includes automatic linking to original offers, preservation of negotiation chains, status tracking across multiple rounds, and relationship visualization in matrix.

```
Offer Evolution Tracking
class OfferHistory:
  track_modification(original_offer, new_offer):
    create_version_link( )
    store_delta_changes( )
    update_dependency_graph( )
    notify_affected_parties( )
Negotiation Timeline
class TimelineManager:
  record_event(event_type, context):
    store_event_data( )
    update_visualizations( )
    check_temporal_rules( )
    maintain_causal_ordering( )
```

The following example highlights how the systems and methods described herein operate in a multi-party scenario which includes conditional requirements. It is provided for exemplary purposes only and is not meant to be taken in a limiting sense. In the present example, there are two claimants (e.g., offering parties C1 and C2) and three respondents (e.g., responding parties R1, R2, and R3). Each party logs into the system using unique credentials and role-based authentication. The system generates a dynamic matrix with two columns for claimants (C1, C2) and three rows for respondents (R1, R2, R3). This creates six potential offer channels.

Claimant C1 creates a standard monetary offer of $10,000 to R1 and $5,000 to R2. C2 creates a combined offer requiring acceptance from R2 and R3 together (e.g., designating R2 and R3 as linked responding parties), each for $3,000, plus a non-monetary condition (e.g., a confidentiality clause). The system automatically links C2's offers to R2 and R3, marking them as a combined offer set. If R2 rejects, then R3's response is also invalidated, ensuring the offer must be accepted or rejected as a unit.

R1 quickly accepts the $10,000 offer from C1. R2 and R3 both tentatively accept C2's $3,000 offer, but R3 adds a revised deadline as a non-monetary counter-condition. The validation engine checks each party's response. Since R2 and R3 remain in partial acceptance, the system flags the combined offer as “pending final acceptance” until all terms align.

Once C2 and R3 finalize the confidentiality clause, and both R2 and R3 confirm acceptance, the system triggers the document generation process. A single integrated settlement agreement is produced, referencing each accepted monetary amount and the additional confidentiality clause. This scenario demonstrates how the matrix interface, conditional linking, real-time validation, and automated document generation streamline multi-party settlement discussions.

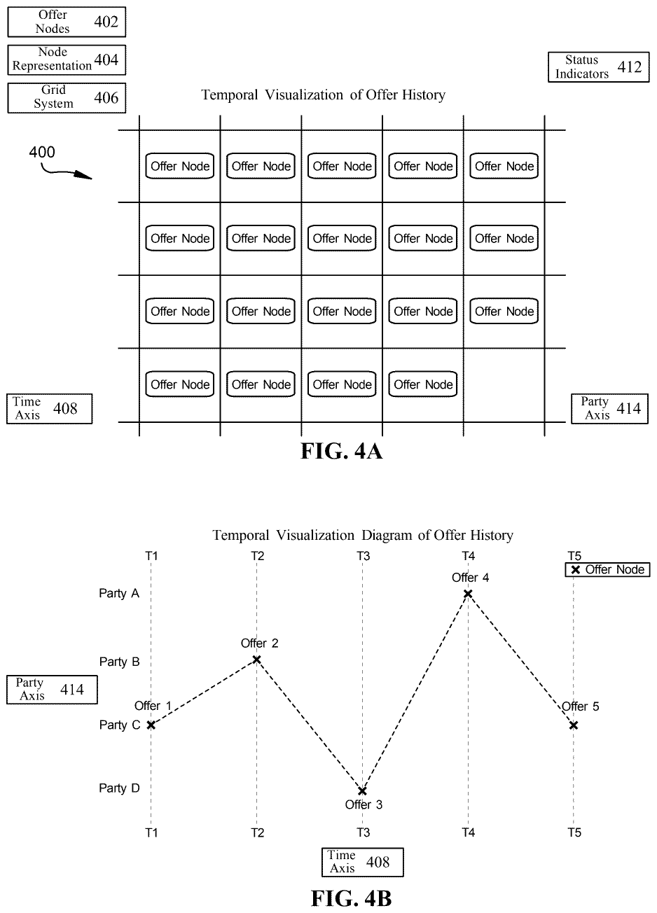

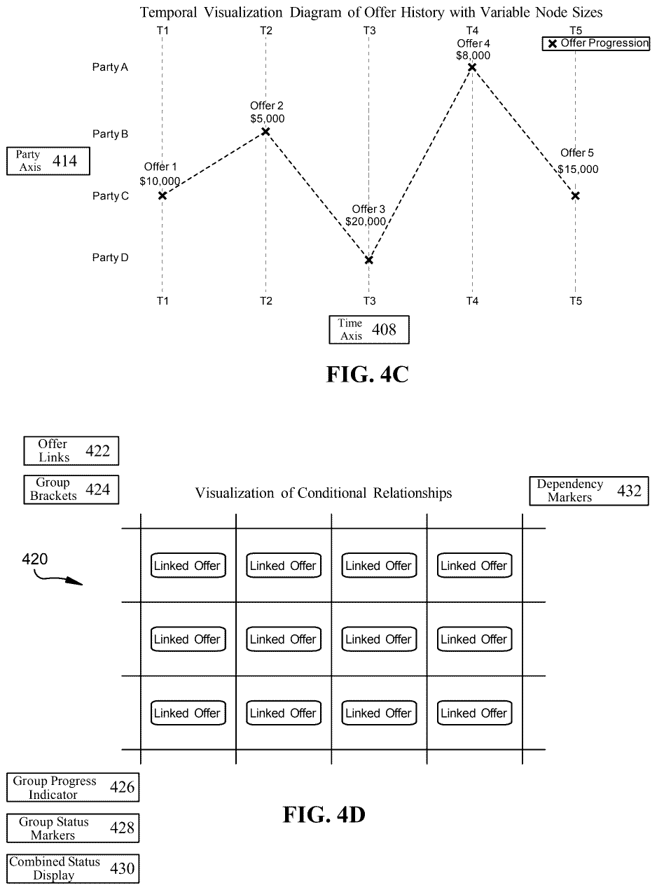

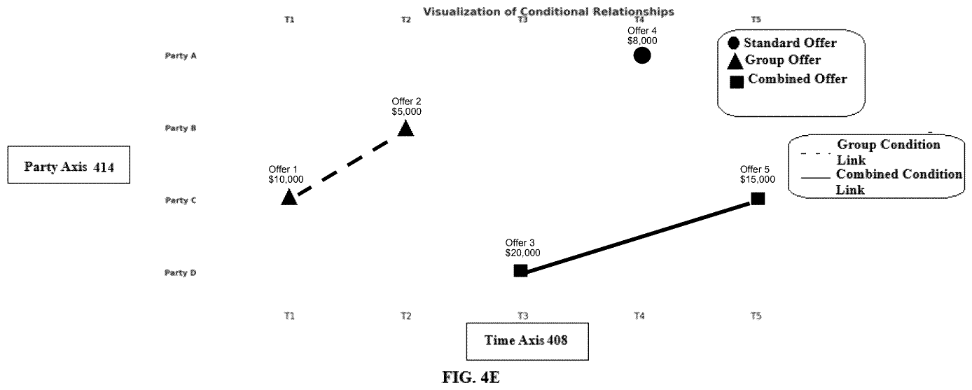

Referring now to FIG. 4A, a temporal visualization diagram 400 is shown. The temporal visualization includes a timeline framework which tracks time stamps on the one or more offers and responses. The temporal visualization diagram 400 is displayed to the parties via an interactive graphical interface (e.g., as shown in FIGS. 4B, 4C, and 4E).

Referring now to FIGS. 4B and 4C, graphical interfaces representing the temporal visualization diagram 400 are shown. The graphical interfaces include a time axis 408 (e.g., the x axis/horizontal axis) which represents a timeline representation of a multi-party settlement negotiation and a party axis 414 (e.g., the y axis/vertical axis) which represents the parties involved in a settlement negotiation. The graphical interfaces include a grid system 406 by which offers/responses can be plotted using time/party intersection points. Offers/responses are represented by offer nodes 402, which are shown on the graphical interface as an ‘X.’ Offer nodes can be varied in size proportionally based on the amount of the monetary value included in the offer (e.g., as can be seen in FIG. 4C). Node representations 404 can include an ‘X’ or any other shape. Multiple types of node representations 404 can be included to differentiate between different parties or different kinds of offers. Status indicators 412 can include a color-coded offer state status display on the graphical user interface. Connections lines are used to connect the offer nodes and represent offer flow visualization. The connection lines can be color coded, solid lines, dotted lines, or any other variation to represent connections between different types of offers.

Offer validation engine 112 (e.g., as described in reference to and shown in FIG. 1A) processes offer data received by the one or more offering parties and calculates relative positions of offer nodes 402. Offer validation engine 112 further generates connection paths (e.g., connection lines), applies visual indicators for group and combined offers, and updates in real time as new offers are made.

With reference to FIG. 4D, a temporal visualization diagram for conditional relationships 420 is shown. The temporal visualization is displayed to the parties via an interactive graphical interface (e.g., as shown in FIG. 4E). The temporal visualization diagram 420 shows a group offer visualization including group brackets 424 (e.g., visual party grouping via connection lines), group progress indicator 426 (e.g., individual acceptance tracking), and group status markers 428 (e.g., overall offer state status display). The temporal visualization diagram 420 also shows combined offer visualization including offer links 422 (e.g., connection lines between related/linked offers), dependency markers 432 (e.g., party relationship indicators), and combined status display 430 (e.g., overall offer state status display).

FIG. 4E shows a graphical interface representing the temporal visualization diagram for conditional relationships 420. The graphical interface includes a time axis 408 (e.g., the x axis/horizontal axis) which represents a timeline representation of a multi-party settlement negotiation and a party axis 414 (e.g., the y axis/vertical axis) which represents the parties involved in a settlement negotiation. The graphical interface includes a grid system 406 by which offers/responses can be plotted using time/party intersection points.

Offers/responses are represented by offer nodes 402. As shown, node representations 404 include a circle representing a standard offer, a triangle representing a group offer, and a square representing a combined offer. Any other shape or marking for the node representation is contemplated herein. As shown, connection lines include a dotted line connecting parties associated with group offers and a solid line connecting linked parties associated with combined offers. Connection lines can be color coded, solid lines, dotted lines, or any other variation to represent connections between different types of offers. The systems and methods as described herein can implement a sophisticated circular dependency detection and resolution.

The following pseudocode and implementation details are presented solely for illustrative purposes to demonstrate one possible embodiment of visual state representation and is not meant to be taken in a limiting manner.

```
Visual State Representation
class Offer Visualizer {
  properties:
    visual_mappings: Map<OfferState, VisualAttributes>
    indicator_controller: StatusIndicator
    animation_manager: TransitionAnimator
  methods:
    update_visual_state(offer_state):
      attributes = visual_mappings.get(offer_state)
      apply_visual_attributes(attributes)
      animate_state_transition( )
      update_accessibility_state( )
```

The systems and methods provided herein allow for concurrent modification and managing of multiple offers and responses from multiple parties including version control for the various offer state statuses, conflict resolution for simultaneous updates, offer state status synchronization (e.g. across related offers), and real-time update propagation of offer state statuses. The systems and methods implement a multi-tiered scalability approach to handle increasing loads and concurrent negotiations. The scalability approach includes a horizontal scaling architecture including a containerized microservices architecture, auto-scaling node clusters, load-balanced application servers, and a distributed catching layer.

The following pseudocode and implementation details are presented solely for illustrative purposes to demonstrate one possible embodiment of the scalability approach and is not meant to be taken in a limiting manner.

```
Horizontal Scaling Infrastructure
      scaling_threshold_config:
  properties:
    resource_utilization: ResourceThreshold
    memory_threshold: MemoryThreshold
    concurrent_user_limit: ScalableLimit
    response_time_threshold: Time Threshold
  methods:
    evaluate_scaling_needs( ):
      monitor_system_metrics( )
      apply_scaling_rules( )
      adjust_resource_allocation( )
```

A database partitioning strategy is included in the scalability approach and can include sharing by negotiation ID, read replicas for heavy query, time-based partitioning for historical data, and hot/cold separation. An exemplary code for a database partitioning strategy is shown below.

```
Database Partitioning Strategy
  active_negotiations: hot_storage
  completed_older_than_30_days: warm_storage
  archived_older_than_1_year: cold storage
```

Caching layer architecture can include multi-level cache implementation, real-time matrix state caching, distributed cache invalidation, and predictive data prefetching. An exemplary code for the caching architecture is shown below.

### Caching Architecture

cache_hierarchy:
L1: local_memory_cache
matrix_current_state
active_user_sessions
L2: distributed_cache
offer_details—party_information
L3: persistent_store
historical_data
audit trails

Also included in the scalability approach are performance optimization techniques which can include lazy loading of historical data, incremental matrix updates, compressed data transmission, and asynchronous validation processing. An exemplary code for performance optimization techniques is shown below.

```
Performance Optimization techniques
matrix_update_strategy:
  if change_affects_visible_cells:
    push_immediate_update( )
  else:
    queue_for_batch_update( )
```

TABLE C

| Component | Scaling Trigger | Action | Monitoring Metric |
|---|---|---|---|
| Matrix UI | Response Time | Scale Frontend | Performance |
| | Threshold | | Metrics |
| Validation | Queue Length | Scale | Queue Status |
| Engine | Threshold | Processing | |
| Database | Resource | Scale Storage | System Metrics |
| | Utilization | | |
| Cache | Cache Efficiency | Adjust Cache | Cache Analytics |

Table C illustrates a load management system associated with the scalability approach.

Resource optimization is also included in the scalability approach and can include dynamic resource allocation, intelligent query optimization, background task scheduling, and memory usage management. An exemplary code for resource optimization is shown below.

```
Resource Optimization
resource_optimizer:
  monitor_system_metrics( )
  if resource_pressure_detected:
    identify_bottleneck( )
    apply_optimization_strategy( )
    measure_improvement( )
```

The scalability approach provides high availability design including geographic distribution, active-active deployment, automatic failover, and data center redundancy. Further, performance monitoring can include real-time metrics collection, performance anomaly detection, automated alerting system, and trend analysis for capacity planning. The systems and methods as described herein can further include a reporting engine which generates negotiation progress summaries, provides statistical analysis of offer patterns, tracks response timing metrics and maintains historical trend analysis. An exemplary code for performance monitoring is shown below.

```
Performance Monitoring
performance_monitor:
  collect_metrics( ):
    response_times[ ]
    error_rates { }
    resource_utilization { }
    user_concurrency[ ]
  analyze_trends( ):
    identify_patterns( )
    predict_scaling_needs( )
    generate_reports( )
```

The scalability approach further includes matrix optimization for large scale including virtual scrolling for large matrices, progressive loading of offer deals, efficient DOM updates, and WebSocket connection pooling. An exemplary code for large scale matrix optimization is shown below.

```
Matrix Optimization for Large Scale
matrix_renderer:
  visible_window = calculate_viewport( )
  render_visible_cells( )
  preload_adjacent_cells( )
  cleanup_off_screen_data( )
```

The above-described scalability architecture ensures the system can efficiently handle growth in number of concurrent negotiations, total number of parties per negotiation, volume of offers and responses, historical data retention, and real-time update processing. The above-described systems and methods maintain performance targets even under increased loads while providing a responsive user experience across all components.

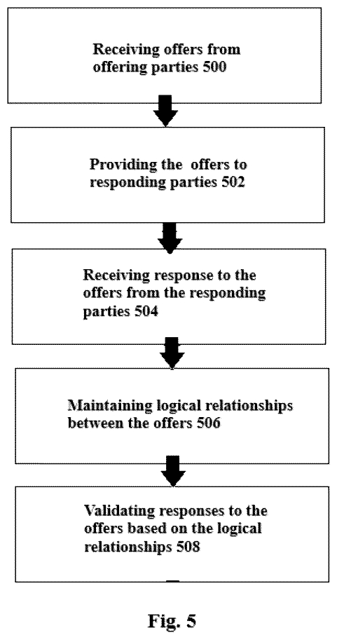

With reference to FIG. 5, a computer-implemented method for generating and displaying a matrix data structure to more efficiently store data points and the relationship and conditions between them. is shown. According to one embodiment, the computer-implemented method comprises receiving one or more offers from one or more offering parties 500 through a user interface 106 (e.g., as shown and described in reference to FIG. 1A) across independent offer channels via a communication network. The computer-implemented method also comprises providing the one or more offers to one or more responding parties 502 through the user interface 106 and receiving one or more responses to the one or more offers from the one or more responding parties 504 via the communication network. The computer-implemented method also comprises maintaining logical relationships between the one or more offers 506 by tracking related offers and conditional dependencies (e.g., as described in more detail in reference to FIG. 8A-8C) and validating responses to the one or more offers based on the logical relationships 508.

In some embodiments, the computer-implemented method can further comprise displaying to the one or more offering parties and the one or more responding parties, through the user interface 106, a visual representation of the multi-party settlement negotiations e.g., graphical user interface as shown in FIGS. 4B, 4C, and 4E).

In certain other embodiments, the user interface 106 (e.g., as shown and described in reference to FIG. 1A) can comprise a dynamic matrix (e.g., as shown in FIGS. 3A-3C). The dynamic matrix can comprise an adjustable series of one or more rows and one or more columns. The adjustable series can be based on a number of the one or more offering parties and the one or more responding parties associated with the multi-party settlement negotiations.

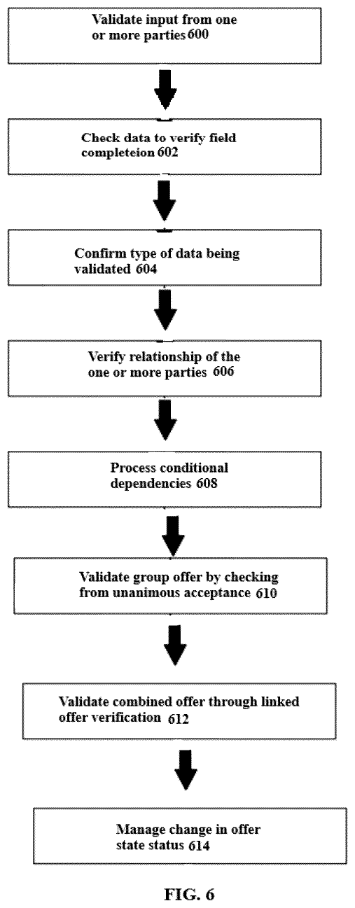

With reference to FIG. 6, a flowchart illustrating the offer validation process is shown. The validation engine 112 (e.g., as shown and described in reference to FIG. 1A) implements complex rules and processing for multi-party offers. The offer validation engine 112 provides real-time validation of incoming offers against system rules, verification of mandatory offer components, validation of party relationships and permissions, and processing of conditional dependencies. The validation engine 112 further provides tracking of party responses, evaluation of group offer conditions, and combined offer validation. The following pseudocode provides an example of how the validation engine 112 evaluates group and combined offers in real-time and is not meant to be taken in a limiting sense.

```
IF offer.type = GROUP_OFFER THEN
  IF allDesignatedRespondingPartiesAccepted(offer) THEN
    offer.status = ACCEPTED
  ELSE
    offer.status = PENDING_UNTIL_ALL_ACCEPT
  ENDIF
ENDIF
IF offer.type = COMBINED_OFFER THEN
  linkedOffers = getLinkedOffers(offer)
  IF anyOfferRejected(linkedOffers) THEN
    setStatusForAll(linkedOffers, REJECTED)
  ELSE IF allOffersAccepted(linkedOffers) THEN
    setStatusForAll(linkedOffers, ACCEPTED)
  ENDIF
ENDIF
```

With continuing reference to FIG. 6, once identifying information and offer data are received from one or more parties (e.g., step 500 in FIG. 5), the system is configured to validate the input from the one or more parties 600. This includes checking the data to verify field completion 602 and confirming the type of data being validated 604 (e.g., a standard offer or an offer including logical relationships and conditional dependencies). The computer-implemented method can further comprise maintaining the logical relationships between the one or more offers by tracking group offers and combined offers. The system does so by verifying if a relationship exists between the one or more offering and responding parties 606 and then processing any conditional dependencies that exist between the one or more offering and one or more responding parties 608.

The system can be further configured to detect and verify the existence of group offer relationships between the parties and combined offer relationships between the parties, both of which include conditional dependencies. Group offers requiring unanimous acceptance by all of the one or more responding parties associated with the multi-party settlement negotiations can be validated by the system. To validate a group offer, the method further comprises checking for unanimous acceptance among the parties 610. This includes detecting a group offer, tracking responses to the group offer from the one or more responding parties, and accepting the group offer upon an agreement from all of the one or more responding parties.

Combined offers requiring offers designated as linked offers by the one or more offering parties to be accepted together can also be validated by the system. The linked offers can be required to be accepted by one or more responding parties designated as linked responding parties by the one or more offering parties. To validate a combined offer, the method further comprises verification of linked offers 612. This includes detecting a combined offer, tracking responses to the combined offer from the one or more linked responding parties, and accepting the combined offer upon an agreement from the one or more linked responding parties. After validation of offers, the method further includes managing changes in offer state status 614 based on detected responses to the offers.

The methods and systems described herein include a status tracking system 236 (e.g., as shown and described with reference to FIG. 1A) which is responsible for managing change in offer state status 614. The status tracking system 236 allows for managing offer lifecycles and ensures consistent and predictable offer lifecycle management while maintaining proper audit trails of all offer state status changes.

In an exemplary embodiment, the following offer states are recognized by the status tracking system 236: 1) DRAFT (e.g., initial creation/not yet submitted), 2) PENDING (e.g., submitted and awaiting responses), 3) PARTIAL (e.g., some but not all required acceptances have been received), 4) ACCEPTED (e.g., all required acceptances have been received), REJECTED (e.g., one or more required parties have rejected), 5) EXPIRED (e.g., time limit exceeded without full acceptance), and 6) WITHDRAWN (e.g., offering party withdrew the offer).

TABLE D

| Current State | Valid Next States | Trigger Conditions |
|---|---|---|
| DRAFT | PENDING, WITHDRAWN | Submission, Withdrawal |
| PENDING | PARTIAL, ACCEPTED, | Response received, Time |
| | REJECTED, EXPIRED, | limit, Withdrawal |
| | WITHDRAWN | |
| PARTIAL | ACCEPTED, REJCTED, | N/A |
| | EXPIRED, WITHDRAWN | |
| ACCEPTED | (Terminal State) | N/A |
| REJECTED | (Terminal State) | N/A |
| EXPIRED | (Terminal State) | N/A |
| WITHDRAWN | (Terminal State) | N/A |

Table D shows the above-described offer states recognized by the system as well as valid next steps after each offer state and trigger conditions for each offer state.

The DRAFT offer state allows modification of all offer terms by parties having role-based permissions. The PENDING offer state locks offer terms and enables response collection from designated responding parties. The PARTIAL offer state maintains acceptance records and tracks remaining requirements. The ACCEPTED offer state triggers the document generation process. The REJECTED offer state maintains a rejection reason and timestamp. The EXPIRED offer state records expiration cause and time. Expiration policies can be created by the one or more parties. As a result of a particular expiration policy, automatic deadlines can be enforced. The WITHDRAWN offer state reserves the withdrawal reason and timestamp.

The following pseudocode and implementation details are presented solely for illustrative purposes to demonstrate one possible embodiment of handling of the partial offer state status and complex dependencies and is not meant to be taken in a limiting manner.

```
Offer State Machine Implementation
class OfferStateMachine {
  properties:
    current_state: OfferState
    allowed_transitions: Map<OfferState, Set<OfferState>>
    state_handlers: Map<OfferState, StateHandler>
  methods:
    initialize_state_machine( ):
      define_state_transitions( )
      setup_state_validators( )
      initialize_state_handlers( )
    transition_state(new_state):
      if is_valid_transition(current_state, new_state):
        execute_pre_transition_hooks( )
        apply_state_change( )
        execute_post_transition_hooks( )
        notify_state_observers( )
    validate_state_transition(current, new):
      if !allowed_transitions[current].contains(new):
        throw new InvalidTransitionError( )
      validate_transition_conditions( )
      check_temporal_constraints( )
Partial Acceptance Lifecycle:
class PartialAcceptanceManager:
properties:
expiration_policy: TimePolicy
resolution_rules: ResolutionConfig
dependency_graph: DirectedGraph<OfferID>
methods:
track_partial_acceptance(offer):
start_expiration_timer( )
monitor_dependencies( )
enforce_resolution_deadlines( )
handle_expiration( ):
notify_all_parties( )
rollback_partial_states( )
clear_dependent_offers( )
Conditional Dependency Resolution:
class DependencyResolver:
resolve_nested_conditions(offer_set):
graph = build_dependency_graph( )
validate_circular_dependencies( )
for level in graph.topological_sort( ):
resolve_level_conditions( )
propagate_status_changes( )
if contains_conflicts( ):
initiate_conflict_resolution( )
State Transition Rules:
class OfferStateManager {
  validate Transition(currentState, newState, trigger):
    switch currentState:
      case DRAFT:
        if trigger == SUBMIT && allFields Valid( ):
          return PENDING
        if trigger == WITHDRAW:
          return WITHDRAWN
      case PENDING:
        if trigger == ACCEPT:
          if isGroupOffer( ) && !allPartiesAccepted( ):
            return PARTIAL
          if allRequiredAcceptancesReceived( ):
            return ACCEPTED
        if trigger == REJECT:
          return REJECTED
        if trigger == TIMEOUT:
          return EXPIRED
      case PARTIAL:
        if trigger == ACCEPT && allRequiredAcceptancesReceived( ):
          return ACCEPTED
        if trigger == REJECT:
          return REJECTED
        if trigger == TIMEOUT:
          return EXPIRED
      // Terminal states have no valid transitions
      case ACCEPTED, REJECTED, EXPIRED, WITHDRAWN:
        return INVALID TRANSITION
State Change Notifications:
      class StateChangeNotifier {
  notifyStateChange(offer, oldState, newState):
    notifyOfferingParty(newState)
    notifyRespondingParties(newState)
    if isGroupOffer( ):
      notifyGroupMembers(newState)
    if isCombinedOffer( ):
      notifyLinkedOffers(newState)
    logStateTransition(offer, oldState, newState)
```

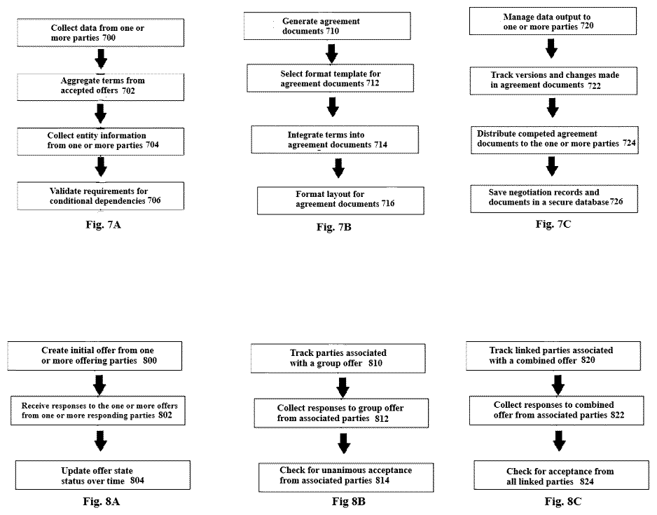

Referring now to FIGS. 7A-7C, a method of document generation showing how accepted offers are converted into settlement documentation is shown. The computer-implemented method can further comprise detecting an acceptance of the one or more offers and generating a settlement document based on the detection of acceptance. As shown in FIG. 7A, the method includes collecting data from the one or more parties 700, which can include data about the parties, data about the negotiation, or any other relevant data available in the system. The terms from accepted offers are then aggregated 702. Entity information is collected from the one or more parties 704. Conditional dependency requirements are validated 706. With the information obtained and aggregated from 700, 702, 704, and 706, agreement documents are generated 710.

As shown in FIG. 7B, generating agreement documents 710 includes selecting a format template for the documents 712, integrating the terms into the agreement documents 714, and formatting the layout of the agreement documents 716. The document generation process can be fully automated but can also allow for manual intervention. Once the documents have been generated, they are sent to the one or more parties for review.

As shown in FIG. 7C, the method continues with managing the data output to the one or more parties 720. Managing the output includes tracking versions and changes made to the agreement documents by the one or more parties 722 (e.g., including document state tracking over time). Once the review and revisions by the one or mor parties is complete, the completed agreement is distributed to the one or more partes 724. Finally, negotiation records and generated documents are saved in a secure database 726.

The enhanced document generation system provides comprehensive term aggregation, structured document assembly, version control and tracking, validation frameworks, external system integration, and secure document management. The following pseudocode and implementation details are presented solely for illustrative purposes to demonstrate one possible embodiment of the document generation system and is not meant to be taken in a limiting manner.

```
Term Aggregation Engine
class TermAggregator {
  properties:
    monetary_terms: Map<PartyID, Map<PartyID, MonetaryTerm>>
    non_monetary_terms: Map<TermType, List<Term>>
    condition_resolver: ConditionResolver
  methods:
    aggregate_settlement_terms(accepted_offers):
      for offer in accepted_offers:
        validate_offer_status(offer)
        extract_monetary_terms(offer)
        process_non_monetary_terms(offer)
        resolve_conditional_dependencies(offer)
    resolve_conditional_dependencies(offer):
      if offer.has_conditions( ):
        dependencies = condition_resolver.get_dependencies(offer)
        validate_dependency_satisfaction(dependencies)
        merge_dependent_terms(offer, dependencies)
Document Assembly System
class DocumentAssembler {
  properties:
    template_engine: TemplateProcessor
    term_formatter: TermFormatter
    validation_rules: Map<DocumentType, ValidationRule>
  methods:
    generate_settlement_document(terms, template):
      validated_terms = validate_term_completeness(terms)
      formatted_terms = format_terms(validated_terms)
      sections = template_engine.process_template(template, {
        monetary_sections: build_monetary_sections(formatted_terms),
        non_monetary_sections: build_non_monetary_sections(formatted_terms),
        party_sections: build_party_sections(formatted_terms),
        signature_blocks: generate_signature_blocks ( )
      })
      return assemble_final_document(sections)
    format_terms(terms):
      return {
        monetary: format_monetary_values(terms.monetary),
        conditions: format_conditions(terms.non_monetary),
        dates: format_dates(terms.temporal),
        parties: format_party_information(terms.parties)
      }
Version Control and Document Management
class DocumentManager {
  properties:
    version_control: Document VersionControl
    storage_manager: SecureStorage
    access_controller: DocumentAccessControl
  methods:
    store_document(document):
      version = version_control.create_version(document)
      metadata = generate_document_metadata(document)
      storage_location = determine_storage_location(metadata)
      return storage_manager.store(version, {
        access_control: setup_access_rules(document),
        retention_policy: determine_retention_policy(document),
        audit_trail: initialize_audit_trail(document)
      })
    manage_document_lifecycle(document_id):
      track_signature_status( )
      handle_document_updates( )
      maintain_version_history( )
      enforce_retention_policies( )
Document Validation Framework
class Document Validator {
  properties:
    validation_rules: Map<DocumentType, List<Rule>>
    term_validators: Map<TermType, Validator>
  methods:
    validate_document(document):
      structural_validation = validate_structure(document)
      content_validation = validate_content(document)
      term_validation = validate_terms(document)
      if has_validation_errors( ):
        generate_validation_report( )
        initiate_correction_workflow( )
    validate_terms(document):
      for term in document.terms:
        validator = term_validators.get(term.type)
        validation_result = validator.validate(term)
        track_validation_result(validation_result)
Integration Points
class DocumentIntegration {
  properties:
    export_formats: Map<FormatType, Formatter>
    external_systems: Map<SystemType, Connector>
  methods:
    export_to_external_system(document, system_type):
      format = determine_export_format(system_type)
      formatted_doc = export_formats[format].format(document)
      return external_systems[system_type].send(formatted_doc, {
        metadata: generate_export_metadata( ),
        tracking: create_export_tracking( ),
        validation: perform_export_validation( )
      })
```

With reference to FIG. 8A, a method for managing a standard offer is shown. The method includes creating an initial offer from one or more offering parties 800, receiving responses to the one or more offers from one or more responding parties 802, and updating an offer state status over time 804 to reflect acceptances, rejections, or counteroffers. The offer state status is created for each of the one or more offers as the one or more offers are received and is updated continuously throughout the multi-party settlement negotiations based on pre-defined roles of the one or more offering parties and the one or more responding parties. The computer-implemented method can further comprise providing an interactive timeline to track the one or more offers and the one or more responses continuously throughout the multi-party settlement negotiations. Tracking the offers and responses in this manner allows the systems and methods as described herein to handle complex timing conflicts with efficiency and accuracy. The systems and methods described herein can handle robust simultaneous updates (e.g., with respect to offers, responses, and offer state status changes) in distributed environments.

FIG. 8B, shows a method for managing a group offer. The method involves tracking parties associated with a group offer 810, collecting responses to the group offer from the associated parties 812, and checking for unanimous acceptance from the associated parties 814. If unanimous acceptance is detected, the offer state status becomes accepted, if any one party associated with the offer rejects the offer, the offer state status becomes rejected. If a party associated with the group offer has yet to respond, the offer state status remains partial until a response has been received from all associated parties.

FIG. 8C shows a method for managing a combined offer. The method involves tracking linked parties associated with a combined offer 820. For example, one or more offering parties can designate one or more responding parties as linked such that their responses of acceptance to an offer must be received together. Tracking the linked parties includes collecting responses to combined offers from the associated linked responding parties 822 and checking for acceptance from all linked responding parties 824. If all linked responding parties accept the combined offer, the offer state status becomes accepted. If any one of the linked responding parties rejects the combined offer, the offer status state becomes rejected. If a linked responding party has yet to respond, the offer state status remains partial until all linked responding parties have responded to the combined offer.

The above-described system and methods implement a sophisticated user management system which includes manual intervention capabilities. The following pseudocode and implementation details are presented solely for illustrative purposes to demonstrate one possible embodiment of user management and manual controls and is not meant to be taken in a limiting manner.

Enhanced Authentication System

```
class AuthenticationManager {
  properties:
    mfa_providers: Map<ProviderType, MFAHandler>
    session_store: DistributedCache<SessionID, SessionState>
    auth_policies: Map<RoleType, AuthPolicy>
  methods:
    authenticate_user(credentials):
      primary_auth = validate_credentials(credentials)
      if primary_auth.requires_mfa:
        mfa_type = determine_mfa_method(primary_auth.user)
        mfa_result = initiate_mfa_challenge(mfa_type)
        validate_mfa_response(mfa_result)
      session = create_secure_session(primary_auth)
      apply_role_policies(session)
      return session_token
    manage_session(session_id):
      current = session_store.get(session_id)
      if session_needs_refresh(current):
        revalidate_authentication(current)
      if session_expired(current):
        initiate_reauth_flow( )
```

Manual Intervention Interface

```
      class ManualResolutionManager {
  properties:
    active_conflicts: Map<ConflictID, ConflictState>
    resolution_workflows: Map<ConflictType, WorkflowTemplate>
    audit_logger: SecureAuditLog
  methods:
    initiate_manual_resolution(conflict):
      workflow = create_resolution_workflow(conflict)
      notify_authorized_parties(workflow)
      track_resolution_progress(workflow)
    handle_manual_override(override_request):
      validate_override_authority(override_request.user)
      impact = analyze_override_impact(override_request)
      if requires_multi_party_approval(impact):
        initiate_approval_workflow(override_request)
      else:
        apply_override(override_request)
      log_override_action(override_request)
```

Resolution Workflow Engine

```
class Resolution Workflow {
  properties:
    steps: List<ResolutionStep>
    approvers: Set<UserID>
    status_tracker: WorkflowStatus
  methods:
    process_resolution_step(step_input):
      validate_step_sequence(step_input)
      current_step = steps.current( )
      if requires_consensus(current_step):
        collect_party_approvals(step_input)
      apply_resolution_action(step_input)
      advance_workflow( )
    handle_escalation(issue):
      escalation_level = determine_escalation_level(issue)
      notified_roles = identify_escalation_roles(escalation_level)
      create_escalation_task(issue, notified_roles)
      track_escalation_response( )
```

TABLE E

| | | | Impact |
|---|---|---|---|
| Scenario | Required Role | Approval Flow | Assessment |
| Deadline | Mediator/Admin | Single | Affected Parties |
| Override | | Approval | |
| Offer | Original Party | Multi-Party | All Related Offers |
| Modification | | | |
| State Reset | Administrator | Consensus | Full Negotiation |
| Role Override | System Admin | Multi-Level | Security Impact |

Table E shows different scenarios involving manual override, the required role for the manual override, approval flow, and impact assessment.

Audit and Compliance Tracking

```
    class ManualActionAuditor {
properties:
  audit_store: Secure AuditStore
  compliance_rules: ComplianceConfig
  notification_engine: NotificationService
methods:
  log_manual_action(action):
    audit_record = create_detailed_record(action)
    validate_compliance(audit_record)
    store_encrypted_record(audit_record)
    notify_relevant_parties(audit_record)
  generate_audit_report(criteria):
    records = fetch_filtered_records(criteria)
    validate_report_access(requesting_user)
    return formatted_report(records)
```

The above-described user management and manual intervention system provides robust multi-factor authentication, secure session management, structured manual intervention processes, clear escalation pathways, comprehensive audit trails for manual actions, role-appropriate override capabilities, and consensus-based resolution workflows. This allows the systems and methods described herein to accommodate a large multitude of users at a time and allow manual intervention when needed.

The present invention further provides a non-transitory computer-readable medium storing instructions that when executed, implement a method for displaying a matrix data structure to more efficiently store data points and the relationship and conditions between them. In one embodiment, the computer-readable method comprises computer code for generating a temporal visualization of one or more offers from one or more offering parties and one or more responding parties, computer code for displaying relationships between the one or more offers via a graphical interface, and computer code for updating a status of the one or more offers continuously as the one or more offers are received from the one or more offering parties and one or more responses are received from the one or more responding parties. Exemplary embodiments of the graphical interfaces generated by the system and displayed to the one or more parties can be seen in FIGS. 4B, 4C, and 4E.

In some embodiments, the computer-readable medium can further comprise computer code for providing interactive elements for viewing details of the one or more offers and the one or more responses and the status of the one or more offers and the one or more responses over time. The relationships between the one or more offering parties and the one or more responding parties can comprise conditional requirements across the one or more offers. The conditional requirements can comprise group offers and combined offers.

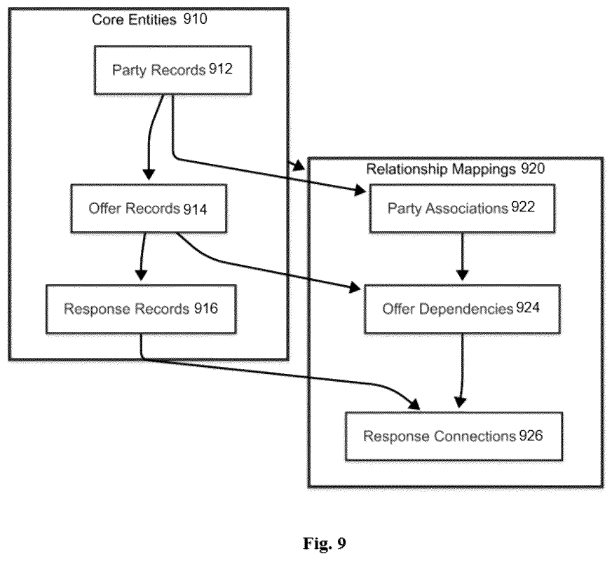

With reference to FIG. 9, a diagram showing the relationships between parties, offers, conditions, and responses is shown. The core entities 910 stored in the system include party records 912, offer records 914 and response records 916. The core entities 910 can be stored in a single database or in multiple separate databases. Party records 912 can include user/organization data including entity information about the offering and responding parties and neutral mediators. Offer records 914 can include settlement term storage, including any changes made to offers overtime. Response records 916 can include tracking responses to the offers including acceptances, rejections, and counteroffers. The following pseudocode and implementations are provided to show an example for a comprehensive data architecture and are not meant to be taken in a limiting sense.

Core Entity Definitions

```
class PartyRecord {
  properties:
    party_id: UUID
    type: PartyType // CLAIMANT, RESPONDENT, MEDIATOR
    profile: {
      organization: OrganizationInfo
      contacts: List<ContactInfo>
      roles: Set<RoleType>
      permissions: Set<Permission>
    }
    relationships: Map<PartyID, RelationshipType>
  methods:
    validate_party_relationship(other_party):
      relationship = relationships.get(other_party.id)
      return validate_relationship_rules(relationship)
```

Offer Data Structure

```
class OfferRecord {
  properties:
    offer_id: UUID
    offering_party: PartyID
    responding_parties: Set<PartyID>
    terms: {
      monetary: Monetary Value
      non_monetary: List<Term>
      conditions: List<Condition>
      deadlines: Set<Deadline>
    }
    state: OfferState
    metadata: {
      created_at: Timestamp
      modified_at: Timestamp
      version: Integer
      audit_trail: List<AuditEntry>
    }
methods:
  create_offer_version( ):
    return new OfferVersion({
      parent: this,
      version: this.metadata.version + 1,
      changes: collect_changes( )
    })
```

Response Tracking

```
class ResponseRecord {
  properties:
    response_id: UUID
    offer_id: UUID
    responding_party: PartyID
    response_type: ResponseType // ACCEPT, REJECT, COUNTER
    terms: {
      accepted_terms: Set<TermID>
      modified_terms: Map<TermID, Term>
      new_terms: List<Term>
    }
    metadata: {
      timestamp: Timestamp
      state: ResponseState
      conditions: List<Condition>
    }
  methods:
    validate_response( ):
      verify_party_authorization( )
      validate_response_timing( )
      check_term_modifications( )
```

The system maps relationships between the parties, offers, and responses. Relationship mapping 920 taking place within the system is shown in FIG. 9. The party records 912 are used to determine party associations 922. The offer records are used to determine offer dependencies 924 (e.g., offering parties designating certain offers as associated with or conditionally linked to each other). Response records 916 are used to determine action associations (e.g., tracking responses of associated responding parties and linked responding parties). An exemplary pseudo code for relationship mapping is provided below.

Relationship Mappings

```
class RelationshipManager {
  properties:
    party_relationships: DirectedGraph<PartyID>
    offer_dependencies: DirectedGraph<OfferID>
    group_mappings: Map<GroupID, Set<PartyID>>
  methods:
    establish_relationship(party1, party2, type):
      validate_relationship_type(type)
      create_relationship_edge(party1, party2, type)
      setup_relationship_constraints( )
    manage_offer_dependencies(offer_set):
      validate_dependency_rules(offer_set)
      create_dependency_links(offer_set)
      maintain_dependency_state( )
```

Data Access Patterns

```
class DataAccessManager {
  properties:
    cache_manager: CacheManager
    query_optimizer: QueryOptimizer
    index_manager: IndexManager
  methods:
    optimize_data_access(query_pattern):
      access_plan = analyze_query_pattern(query_pattern)
      optimized_plan = query_optimizer.optimize(access_plan)
      return execute_optimized_plan(optimized_plan)
    manage_data_lifecycle(entity):
      current_state = analyze_entity_state(entity)
      storage_tier = determine_storage_tier(current_state)
      migrate_entity_data(entity, storage_tier)
```

TABLE F

| Data Type | Storage Approach | Access Pattern | Retention Policy |
|---|---|---|---|
| Active Offers | Hot Storage | Real-time | While Active |
| Recent History | Warm Storage | Interactive | 30 Days |
| Archived Data | Cold Storage | Batch | Configurable |
| Audit Trails | Immutable Store | Sequential | Legal Requirement |

Table F provides storage strategies for various types of data received by the system including storage approach, access pattern, and retention policy.

Data Consistency Rules

```
class ConsistencyManager {
  enforce_data_consistency( ):
    validate_referential_integrity( )
    check business rules( )
    verify_state_transitions( )
    maintain_audit_records( )
  handle_consistency_violation(violation):
    identify_violation_scope( )
    initiate_correction_procedure( )
    notify_affected_parties( )
    log_violation_details( )
```

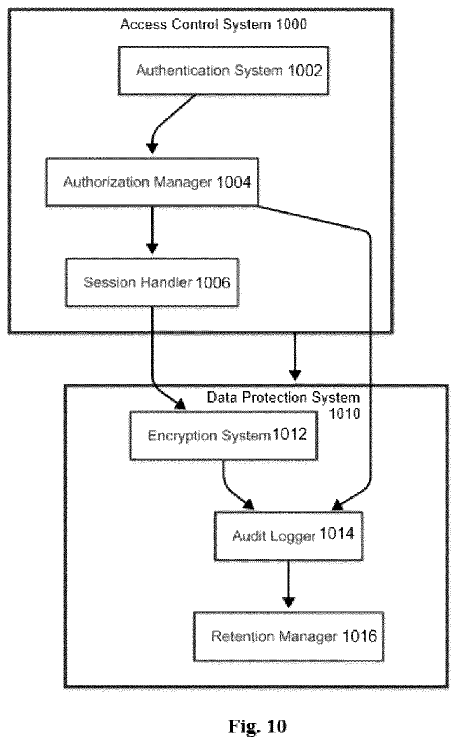

Referring now to FIG. 10, the security and data retention architecture of the system is shown. The security and data retention architecture includes an access control system 1000 and a data protection system 1010. The access control system, 1000 further includes an authentication system 1002 (e.g., multi-factor authentication with configurable providers) used for identity verification of the one or more offering parties, one or more responding parties, and any third-party neutral mediators. The access control system 1000 also includes authorization manager 1004 which includes permission controls which allow certain parties and mediators to have access to various parts of the system. The access control system 1000 also includes a session handler 1006 which includes offer state management.

The data protection system 1010 includes an encryption system 1012 used for data security. An audit logger 1014 is also included for activity tracking (e.g., changes to offers and responses over time throughout the course of a settlement negotiation as well as comprehensive audit trails for all manual interventions). The data protection system 1010 also includes a retention manager 1016 which includes data lifecycle control and a retention manager which provides sophisticated session management with automatic revalidation.

Data protection can include but is not limited to encryption of all stored negotiation data, segregation of active and historical negotiation data, automated data retention management system, cold storage for inactive negotiations, configurable retention periods, and protected audit trails. Security based access control can include but is not limited to role-based authentication system, party-specific access restrictions, temporal limits on offer visibility, and comprehensive action logging. Network security includes but is not limited to end-to-end encryption, secure communication protocols, multi-factor authentication, and session management. The systems and methods described herein can also provide network delay compensation via a propagation delay handler.

The security and data retention architecture includes a comprehensive audit system including extensive error handling and recovery procedures. Transaction recovery protocols can include but are not limited to distributed transaction logging, two-phase commit for critical operations, rollback procedures for failed operations, and state reconstruction from event logs.

Further, the security and data retention architecture includes communication failure recovery which provides automatic session restoration, message queue persistence, last-known good state tracking, and progressive backoff retry logic. Audit and compliance capabilities are also handled by the system including complete error logging, recovery action tracking, compliance verification, regulatory notification system, automated reconciliation procedures, and manual intervention triggers. This comprehensive security and audit system ensures robust operation while maintaining data integrity and user trust throughout the negotiation process. The following pseudocode and implementation details are presented solely for illustrative purposes to demonstrate one possible embodiment of security and data retention features and is not meant to be taken in a limiting manner.

Offer Validation Error Handling

```
try:
  validate_offer_submission(offer_data):
    verify_party_authorization( )
    check_offer_completeness( )
    validate_conditional_dependencies( )
    ensure_temporal_consistency( )
  if validation_error:
    log_validation_failure(error_type, context)
    notify_submitting_party(error_details)
    preserve_partial_state( )
    suggest_correction_steps( )
  if network_error:
    queue_for_retry(max_attempts=3)
    maintain_local_cache( )
    notify_system_admin(if_persistent)
  if concurrent_modification:
    apply_conflict_resolution( )
    notify_affected_parties( )
```

Out-of-Sequence Response Handling

```
when receive_response(offer_id, party_id, response):
  current_state = get_offer_state(offer_id)
  if response.timestamp < current_state.last_update:
    flag_temporal_inconsistency( )
    notify_responding_party(state_mismatch)
    request_response_confirmation( )
  if offer_expired_or_invalidated:
    reject_response(reason=OFFER_NO_LONGER_VALID)
    suggest_alternative_actions( )
```

TABLE G

| | | Recovery | |
|---|---|---|---|
| Error Condition | Detection Method | Action | Notification |
| Network | Heartbeat Fail | Retry Queue | User + Admin |
| Timeout | | | |
| Data Corruption | Checksum | State Rebuild | Admin Only |
| | Mismatch | | |
| Auth Failure | Token Invalid | Reauthorize | User |
| Concurrent | Version | Merge/Resolution | All Affected |
| Conflict | Mistmatch | | |

Table G provides different error conditions that the systems and methods described herein are configured to detect and manage.

Recovery Prioritization

```
classify_error_severity(error):
  if affects_multiple_parties:
    priority = HIGH
    initiate_immediate_recovery( )
  else if affects_single_offer:
    priority = MEDIUM
    queue_for_next_recovery_cycle( )
  else:
    priority = LOW
    handle_during_maintenance( )
```

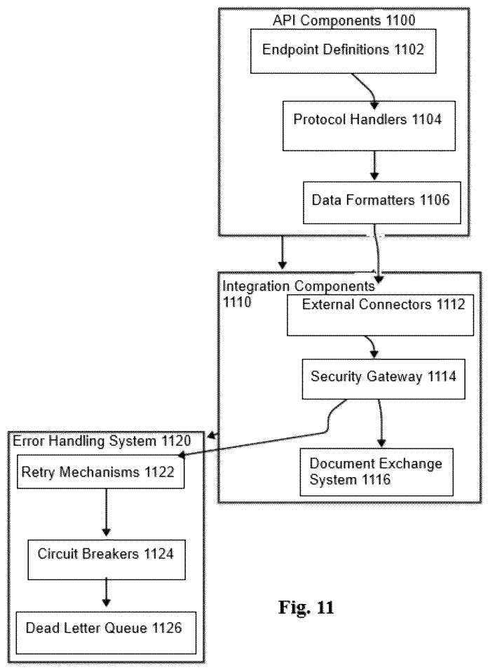

Referring now to FIG. 11, an API integration framework for connecting the system with external legal systems is shown. The API integration framework includes API components 1100, Integration Components 1110, and Error Handling Components 1120. The external system integration includes API endpoints for court system integration, law firm practice management systems, document management systems, standardized data exchange protocols, and real-time synchronization capabilities. The document management system provides a secure document upload system, version control for uploaded documents, reference linking between documents and settlement terms, and automated document routing based on settlement status.

The API components 1100 include endpoint definitions 1102 including RESTful service interfaces implementing OAuth 2.0 authentication flow, JWT token validation, rate limiting and throttling, and versioned API endpoints (/v1/,/v2/). The API components 1100 also include protocol handlers 1104, which are communication protocols including HTTPS/2 for synchronous operations, WebSocket (WSS) for real-time updates, and gRPC for high-performance integrations. The API components 1100 further include data formatters 1106 which provide data exchange standardization such as JSON Schema validation, XML DTD compliance, and protocol buffers for binary encoding.

The API integration framework integration components 1110. The integration components 1110 include external connectors 1112, for example, specialized interfaces for court e-filing systems (e.g., PACER, state courts), practice management platforms (e.g., Clio, PracticePanther), document management systems (e.g., iManage, NetDocuments), electronic signature services, and financial transaction services. Integration components 1110 also include security gateway 1114 which provides advanced authentication including multi-factor authentication, IP whitelisting, and certificate-based mutual TLS. Further, the integration components 1110 include document exchange systems 1116 which provide document handling with PDF/A compliance, digital signature integration (e.g., DocuSign, Adobe Sign), and blockchain-based audit trails.

Additionally, the API integration framework includes an error handling component 1120 which includes retry mechanisms 1122 (e.g., exponential backoff), circuit breakers 1124 (e.g., failure isolation), and dead letter queues 1126 (e.g., failed message handling).

The above-described document management and integration system includes document workflow management including automated routing based on settlement status, parallel review process, version comparison tools, and change tracking and annotation. Integration features include external document management system (DMS) connectivity, court e-filing system integration, legal practice management software compatibility, and standardized export formats. Document retention includes policy-based retention schedules, automated archiving processes, legal hold management, and compliance documentation. The pseudocode and implementation details provided are presented solely for illustrative purposes to demonstrate one possible embodiment of document management integration.

E-Signature Integration

```
class SignatureWorkflow:
  initialize_signing_sequence( ):
    validate_document_readiness( )
    determine_signer_order( )
    generate_signature_blocks( )
  track_signature_status( ):
    monitor_completion( )
    validate_signatures( )
    maintain_chain_of_custody( )
```

Version Control System

```
class DocumentVersion:
  properties:
    version_id: UUID
    parent_version: UUID
    changes: List<DocumentChange>
    signatures: Map<PartyID, SignatureStatus>
  methods:
    create_new_version( ):
      clone_current_state( )
      apply_changes( )
      update_metadata( )
      notify_stakeholders( )
```

In addition to everything described above, the systems and methods described herein further implement sophisticated mechanisms for handling conditional dependencies, timing conflicts, and edge cases. The comprehensive management system integrates partial acceptance handling with configurable expiration policies, automatic deadline enforcement, cascading status updates, and resolution escalation procedures. This enhanced system ensures deterministic handling of circular dependencies, precise timing conflict resolution, network delay compensation, robust edge case management, and verifiable state consistency.

The following pseudocode and implementation details provided are presented solely for illustrative purposes to demonstrate one possible embodiment of handling conditional dependencies, timing conflicts, and edge cases.

Dependency Graph Implementation

```
class DependencyGraph {
  properties:
    nodes: Map<OfferID, OfferNode>
    edges: Map<OfferID, Set<OfferID>>
    metadata: Map<EdgeID, DependencyMetadata>
  methods:
    addDependency(sourceOffer, targetOffer, type):
      validateCircular(sourceOffer, targetOffer)
      edges[sourceOffer].add(targetOffer)
      metadata[generateEdgeID(source, target)] = {
        type: type,
        timing_constraints: extractTimingConstraints( ),
        resolution_rules: getDependencyRules(type)
      }
    validateCircular(source, target):
      visited = new Set( )
      stack = new Stack( )
      return detectCycle(source, visited, stack)
    detectCycle(node, visited, stack):
      visited.add(node)
      stack.push(node)
      for neighbor in edges[node]:
        if !visited.has(neighbor):
          if detectCycle(neighbor, visited, stack):
            return buildCycleResolutionPlan(stack)
        else if stack.contains(neighbor):
          return buildCycleResolutionPlan(stack)
      stack.pop(node)
      return null
```

Conflict Resolution Engine

```
class ConflictResolver {
  properties:
    stateManager: StateManager
    conflictDetector: ConflictDetector
    mergeEngine: MergeEngine
  methods:
    handleConflict(conflict):
      if canAutoResolve(conflict):
        resolution = autoResolveConflict(conflict)
        applyResolution(resolution)
      else:
        initiateManualResolution(conflict)
    autoResolveConflict(conflict):
      strategy = determineResolutionStrategy(conflict)
      return strategy.resolve(conflict)
```

Timing Conflict Resolution

```
class TimingManager {
  properties:
  deadlineQueue: PriorityQueue<Deadline>
  expirationPolicies: Map<OfferType, Policy>
    propagationDelays: Map<PartyID, NetworkStats>
  methods:
    resolveDeadlineConflicts(offers):
      deadlines = extractDeadlines(offers)
      conflicts = findOverlappingDeadlines(deadlines)
      for conflict in conflicts:
        if isCircularDependency(conflict):
          resolveCircularTimingConflict(conflict)
        else:
          resolveLinearTimingConflict(conflict)
    resolveCircularTimingConflict(conflict):
      cycle = findDependencyCycle(conflict)
      breakpoint = determineOptimalBreakPoint(cycle)
      reorderDeadlines(cycle, breakpoint)
      notify AffectedParties(cycle)
    handlePropagationDelay(response):
      estimatedDelay = calculateNetworkDelay(response.party)
      if withinAcceptableLatency(estimatedDelay):
        adjustTimestamps(response, estimatedDelay)
        processResponse(response)
      else:
        initiateResyncProtocol(response.party)
```

Edge Case Resolution

```
class EdgeCaseResolver {
  resolveConflictingUpdates(offer):
    versions = collectConcurrent Versions(offer)
    if canAutoMerge(versions):
      return performStructuredMerge(versions)
    else:
      return initiateManualResolution(versions)
  handlePartialStateExpiration( ):
    for offer in findExpiredPartialStates( ):
      if canExtendDeadline(offer):
        proactivelyExtendDeadline(offer)
      else: gracefullyTerminate(offer)
```

TABLE H

| | Detection | | Fallback |
|---|---|---|---|
| Scenario | Method | Primary Strategy | Strategy |
| Circular | Graph Analysis | Break at Lowest | Manual |
| Dependency | | Impact | Resolution |
| Deadline | Timeline Scan | Auto-adjust | Party |
| Overlap | | Windows | Notification |
| Concurrent | Version Check | Latest Wins | Merge |
| Updates | | | |
| Network Delay | Latency Monitor | Timestamp Adjust | Resync |
| | | | Protocol |
| Partial | Timer Event | Deadline Extension | Graceful |
| Acceptance | | | Termination |
| Timeout | | | |

Table H provides alternative exemplary resolution strategies matrix scenarios in addition to the dynamic matric which has been described throughout.

State Consistency Enforcement

```
class ConsistencyManager {
  properties:
    state Versions: Map<OfferID, Version Vector>
    pendingUpdates: Queue<StateUpdate>
  methods:
    enforceConsistency(offer):
      current = getDistributedState(offer)
      if hasInconsistencies(current):
        conflicts = identifyConflicts(current)
        resolution = resolveConflicts(conflicts)
        propagateResolution(resolution)
        verifyConsistency(offer)
```

Partial Acceptance Management

```
class PartialAcceptanceManager {
  properties:
    expiration_policy: TimePolicy
    resolution_rules: ResolutionConfig
    dependency_graph: DirectedGraph<OfferID>
  methods:
    track_partial_acceptance(offer):
      start_expiration_timer( )
      monitor_dependencies( )
      enforce_resolution_deadlines( )
    handle_expiration( ):
      notify_all_parties( )
      rollback_partial_states( )
      clear_dependent_offers( )
```

The systems and methods described herein simplify complex multi-party negotiations by providing clear visualization of offers, automated validation of acceptance conditions, and structured document generation, while maintaining data security and confidentiality throughout the negotiation process. The systems and methods described herein enhance transparency and improve efficiency in multi-party settlements. The systems and methods described herein address technical challenges in coordinating, visualizing, and processing settlement offers between multiple parties in legal proceedings, with particular emphasis on managing conditional dependencies and temporal relationships between multiple concurrent settlement offers. This system and method can be applied in legal practice management systems, alternative dispute resolution platforms, and court-annexed settlement programs where multiple parties must coordinate complex settlement terms.

All pseudocode and implementation details provided throughout this specification are presented solely for illustrative purposes to demonstrate one possible embodiment of the systems and methods described herein. These specific implementations are non-limiting examples, and one skilled in the art will recognize that the invention may be implemented using different programming languages, algorithms, data structures, architectures, and technical approaches while remaining within the spirit and scope of the claims. The specific details provided serve to enable one skilled in the art to practice the invention but should not be construed as limiting the invention to only these implementations.

While specific embodiments have been described above, one having ordinary skill in the art would understand that the systems and methods described herein can be implemented in various alternative ways. For example, the dynamic user interface can include circular visualizations, hierarchal structures, and/or network graphs. The dynamic user interface can also include mobile-optimized vertical scrolling interfaces. In alternate embodiments, the party configuration can include asymmetric or dynamic party addition/removal and nested party hierarchies. As an added security measure, proxy representation for authorized representatives may be required.

In some embodiments, conditional offer variations can be managed by the system. For example, time-limited offers, sequential offers, and/or threshold-based offers. Conditional offers can further include partial acceptance scenarios for divisible offers and contingent offers dependent on external events. In some alternative embodiments, the document generation system can include multiple template formats (e.g., PDF, Word, and HTML). The document generation system can further be configured to include multi-language support and structured data exports (e.g., JSON, XML, and CSV).

In certain other alternate embodiments, additional security implementations can include blockchain-based audit trails. Multi-factor authentication and biometric access control can also be used by the system for allowing access to parties. Security implementations can further include distributed storage architectures. In addition to the visual aid described herein, alternate embodiments of visual alternatives can include Gantt charts, heat maps, 3D visualizations, and/or animated timelines of the negotiation process.

Alternative implementations may use different programming paradigms or languages, employ alternative data structures or algorithms, utilize different architectural patterns, implement different state management approaches, or choose alternative technical solutions for achieving the claimed functionality. The system and methods for managing and visualizing multi-party settlement negotiations through a dynamic matrix interface can be realized through various technical approaches, including but not limited to different user interface technologies beyond web-based implementations, alternative database architectures and storage solutions, various distributed computing paradigms, different security and authentication frameworks, alternative document generation and processing methods, various approaches to handling conditional dependencies, or different visualization techniques for temporal data.

The technical implementation details described herein demonstrate enablement and best mode without limiting the scope of the invention to these specific examples. The invention encompasses any implementation that achieves the fundamental purpose of facilitating multi-party settlement negotiations through a dynamic matrix-based system, regardless of the specific technical approach used.

Furthermore, as technology evolves, the systems and methods described herein may be implemented using future technologies not currently known or available, while still remaining within the scope of the claims. The essential characteristics of the systems and methods described herein are not dependent on any particular technology stack or implementation approach.

The systems and methods described herein may be implemented across various computing environments and hardware configurations, including but not limited to computing platforms, client devices, and network configurations. Computing platforms can include but are not limited to traditional server infrastructures, cloud-based deployments, hybrid cloud environments, edge computing architectures, containerized environments, virtualized infrastructure, and distributed systems. Client devices can include but are not limited to desktop computers, mobile devices, tablet computers, web browsers, native applications, and progressive web applications. Network configurations can include but are not limited to local area networks, wide area networks, cloud networks, private networks, hybrid networking environments, and content delivery networks.

The system architecture is hardware-agnostic and can be adapted to various deployment models, including single-server deployments, distributed micro-services, serverless architectures, multi-region deployments, high-availability configurations, and disaster recovery setups. The functionality of the systems and methods described herein is not dependent on any specific hardware configuration, and the system can be scaled horizontally or vertically based on specific implementation needs and available computing resources.

The systems and methods described herein can include any suitable type of network allowing transport of data across thereof. A network may couple devices so that data may be exchanged, such as between servers and user devices, including between wireless devices coupled via a wireless network, for example. A network may also include mass storage, such as network attached storage (NAS), a storage area network (SAN), cloud computing and storage, or other forms of computer or machine-readable media, for example. In one embodiment, a network may be the Internet, following known Internet protocols for data communication, or any other communication network, e.g., any local area network (LAN) or wide area network (WAN) connection, cellular network, wire-line type connections, wireless type connections, or any combination thereof.

Data and content stored and/or transmitted to and from user devices may be encrypted using, for example, the Advanced Encryption Standard (AES) with a 128, 192, or 256-bit key size, or any other encryption standard known in the art.

The systems and methods described herein can include servers which may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory for storing instructions or applications for the performance of various functions and a corresponding processor for executing stored instructions or applications. For example, the memory may store an instance of the server configured to operate in accordance with the disclosed embodiments.

FIGS. 1A through 1I are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

1. Non-transitory computer readable media comprising computer program code that when executed by a programmable processor causes execution of a method performed by a computer system for automatically generating and displaying a matrix data structure to more efficiently store data points and relationships and conditions between them, the non-transitory computer readable medium comprising:
computer program code for receiving, across independent offer channels over a communication network, one or more offers from one or more offering parties through a user interface;
computer program code for providing the one or more offers to one or more responding parties through the user interface via the communication network;
computer program code for receiving one or more responses to the one or more offers from the one or more responding parties via the communication network;
computer program code for maintaining logical relationships between the one or more offers by tracking related offers and conditional dependencies; and
computer program code for displaying to the one or more offering parties and the one or more responding parties, through the user interface, a visual representation of multi-party settlement negotiations, the multi-party settlement negotiations comprising the one or more offers and the one or more responses over time, wherein the visual representation comprises a dynamic matrix user interface comprising a dynamic tabular visualization of an adjustable series of rows and columns, the columns representing the one or more offering parties and the rows representing the one or more responding parties, the dynamic tabular visualization comprising a plurality of cells, each cell formed by an intersection of a row and column and representing a potential independent offer channel between an offering party and a responding party;
wherein the computer program code for displaying the visual representation is configured to dynamically adjust the dynamic matrix user interface by disabling excess columns and rows not selected by a user such that only active offer channels are managed and to synchronize updates to the dynamic matrix user interface in real-time across a communication network via a WebSocket connection utilizing optimistic user interface (UI) updates.

2. The non-transitory computer readable media of claim 1, further comprising computer program code for:
creating a status of an offer state for each of the one or more offers as the one or more offers are received;
updating the status of the offer state continuously throughout the multi-party settlement negotiations; and
synchronizing the status updates to the dynamic matrix user interface in real-time.

3. The non-transitory computer readable media of claim 2, further comprising computer program code for:
updating the status of the offer state based on pre-defined roles of the one or more offering parties and the one or more responding parties; and
synchronizing the status updates to the dynamic matrix user interface in real-time.

4. The non-transitory computer readable media of claim 1 further comprising computer program code for providing an interactive timeline to track the one or more offers and the one or more responses continuously throughout the multi-party settlement negotiations.

5. The non-transitory computer readable media of claim 1, wherein the user interface is a secure user interface comprising a unique login and authentication for each of the one or more offering parties and each of the one or more responding parties accessing the user interface.

6. (canceled)

7. The non-transitory computer readable media of claim 1, further comprising computer program code for maintaining the logical relationships between the one or more offers by tracking any group offers and any combined offers.

8. The non-transitory computer readable media of claim 7, wherein the group offers require unanimous acceptance by all of the one or more offering parties and all of the one or more responding parties associated with the multi-party settlement negotiation.

9. The non-transitory computer readable media of claim 8, further comprising computer program code for:
detecting a group offer;
tracking responses to the group offer from the one or more responding parties; and
accepting the group offer upon an agreement from all of the one or more responding parties.

10. The non-transitory computer readable media of claim 7, wherein the combined offers require offers designated as linked offers by the one or more offering parties to be accepted together, wherein the linked offers are required to be accepted by one or more responding parties designated as linked responding parties by the one or more offering parties.

11. The non-transitory computer readable media of claim 10, further comprising computer program code for:
detecting a combined offer;
tracking responses to the combined offer from the one or more linked responding parties; and
accepting the combined offer upon an agreement from the one or more linked responding parties.

12. The non-transitory computer readable media of claim 1, further comprising computer program code for:
detecting an acceptance of the one or more offers; and
generating settlement documents based on the detection of acceptance.

13. The non-transitory computer readable media of claim 1, further comprising computer program code for implementing role-based access control.

14. A computer-implemented method for generating and displaying a matrix data structure to more efficiently store data points and the relationships and conditions between them, comprising:
receiving, across independent offer channels via a communication network, one or more offers from one or more offering parties through a user interface;
providing the one or more offers to one or more responding parties through the user interface via the communication network;
receiving one or more responses to the one or more offers from the one or more responding parties via the communication network;
maintaining logical relationships between the one or more offers by tracking related offers and conditional dependencies;
displaying to the one or more offering parties and the one or more responding parties, through the user interface, a visual representation of multi-party settlement negotiations, the multi-party settlement negotiations comprising the one or more offers and the one or more responses over time, wherein the visual representation comprises a dynamic matrix user interface comprising a dynamic tabular visualization of an adjustable series of rows and columns, the columns representing the one or more offering parties and the rows representing the one or more responding parties, the dynamic tabular visualization comprising a plurality of cells, each cell formed by an intersection of a row and column and representing a potential independent offer channel between an offering party and a responding party;
dynamically adjusting the dynamic matrix user interface by disabling excess columns and rows not selected by a user such that only active offer channels are managed; and
synchronizing updates to the dynamic matrix user interface in real-time across a communication network via a WebSocket connection utilizing optimistic user interface (UI) updates.

15. The method of claim 14, further comprising:
creating a status of an offer state for each of the one or more offers as the one or more offers are received;
updating the status of the offer state continuously throughout the multi-party settlement negotiations based on pre-defined roles of the one or more offering parties and the one or more responding parties; and
synchronizing the status updates to the dynamic matrix user interface in real-time.

16. The method of claim 14, further comprising providing an interactive timeline to track the one or more offers and the one or more responses continuously throughout the multi-party settlement negotiations.

17. The method of claim 14, further comprising maintaining the logical relationships between the one or more offers by tracking group offers and combined offers.

18. A non-transitory computer-readable medium storing instructions that when executed, implement a method for displaying a matrix data structure to more efficiently store data points and relationships and conditions between them, comprising:
computer code for generating a temporal visualization of one or more offers from one or more offering parties and one or more responding parties;
computer code for displaying relationships between the one or more offers via a graphical interface;
computer code for updating a status of the one or more offers continuously as the one or more offers are received from the one or more offering parties and one or more responses are received from the one or more responding parties; and
computer code for displaying to the one or more offering parties and the one or more responding parties, through the graphical interface, a visual representation of multi-party settlement negotiations, the multi-party settlement negotiations comprising the one or more offers and the one or more responses over time, wherein the graphical interface comprises a dynamic matrix user interface comprising a dynamic tabular visualization of an adjustable series of rows and columns, the columns representing the one or more offering parties and the rows representing the one or more responding parties, the dynamic tabular visualization comprising a plurality of cells, each cell formed by an intersection of a row and column and representing a potential independent offer channel between an offering party and a responding party;
wherein the computer code for displaying the visual representation is configured to dynamically adjust the dynamic matrix user interface by disabling excess columns and rows not selected by a user such that only active offer channels are managed and to synchronize updates to the dynamic matrix user interface in real-time across a communication network via a WebSocket connection utilizing optimistic user interface (UI) updates.

19. The computer-readable medium of claim 18, further comprising computer code for providing interactive elements for viewing details of the one or more offers and the one or more responses and the status of the one or more offers and the one or more responses over time.

20. The computer-readable medium of claim 18, wherein the relationships comprise conditional requirements across the one or more offers, the conditional requirements comprising group offers and combined offers.
